(19) United States
(12) Patent Application Publication
(10) Pub. No.: US 2026/0265568 A1
(43) Pub. Date: Sep. 10, 2026

(54) VINYL RESOLE PHENOLIC RESIN, COATING COMPOSITIONS FORMED THEREFROM, ARTICLES AND METHODS OF COATING

(71) Applicant: SWIMC LLC, Cleveland, OH (US)

(72) Inventors: Nusrah HUSSAIN, Gibsonia, PA (US); Jose Luis Martinez CARBALLIDO, Cranberry Township, PA (US); Yingchao ZHANG, Murrysville, PA (US)

(21) Appl. No.: 19/167,544

(22) PCT Filed: Apr. 3, 2024
(86) PCT No.: PCT/US2024/022802

§ 371 Date: Sep. 22, 2025

Related U.S. Application Data
(60) Provisional application No. 63/456,962, filed on Apr. 4, 2023.

(51) Int. Cl. C09D 125/18; B65D 5/56; C09D 167/06

(52) U.S. Cl. CPC C09D 125/18; B65D 5/563; C09D 167/06

(57) ABSTRACT

A vinyl resole phenolic resin is provided. In one aspect, the vinyl resole phenolic resin is combined with a second polymer and an optional carrier to form a coating composition suitable for use in coated articles such as packaging and food and beverage container articles. In one aspect, a method of coating using the coating composition is provided.

### CROSS REFERENCE TO RELATED APPLICATION

This application claims the benefit of U.S. Provisional Application No. 63/456,962 filed on Apr. 4, 2023, which is incorporated herein by reference in its entirety.

### TECHNICAL FIELD

This disclosure relates to a vinyl resole phenolic resin for coating compositions, coating compositions including the vinyl resole phenolic resin, articles coated with the coating compositions, and methods of coating using the coating compositions.

### BACKGROUND

The application of coatings to metals to retard or inhibit corrosion is well established. This is particularly true in the area of metal food and beverage containers. Coatings are typically applied to the interior of such containers to prevent the contents from contacting the metal of the container. Contact between the metal and the packaged product can lead to corrosion of the metal container, which can contaminate the packaged product. This is particularly true when the contents of the container are chemically aggressive in nature. Protective coatings are also applied to the interior of food and beverage containers to prevent corrosion of the container, for example, in the headspace of the container between the fill line of the food product and the container lid, which is particularly problematic with high-salt-content food products. Such coatings may also be advantageously applied to the exterior of food and beverage containers to provide similar protections.

Packaging or container coatings should preferably be capable of high-speed application to the substrate and provide the necessary properties when hardened to perform in this demanding end use. For example, the coating should be safe for food-contact; not adversely affect the taste of the packaged food or beverage product; have excellent adhesion to the substrate; resist staining and other coating defects such as “popping,” “blushing” and/or “blistering;” and resist degradation over long periods of time, even when exposed to harsh environments. In addition, the coating should generally be capable of maintaining suitable film integrity during container fabrication and be capable of withstanding the processing conditions that the container may be subjected to during product packaging. In addition, the coating should have sufficient flexibility to survive routine can drop events (e.g., a can falling off a lower grocery store shelf) without fracturing.

Various coatings have been used as interior and exterior protective can coatings, including epoxy-based coatings and polyvinyl-chloride-based coatings. Each of these coating types, however, has potential shortcomings. For example, the recycling of materials containing polyvinyl chloride or related halide-containing vinyl polymers can be problematic. There is also a desire to reduce or eliminate certain BPA-based epoxy compounds commonly used to formulate food-contact epoxy coatings.

To address the aforementioned shortcomings, the packaging coatings industry has sought coatings based on alternative binder systems that exclude BPA-based epoxy compounds. It has been problematic, however, to formulate such coatings that exhibit the required balance of coating characteristics (e.g., flexibility, adhesion, corrosion resistance, stability, resistance to crazing, etc.). For example, there has been a tradeoff between corrosion resistance and fabrication properties for such coatings. Some coatings suitable for food contact that have exhibited both good fabrication properties and an absence of crazing having tended to be too soft and exhibit unsuitable corrosion resistance. Conversely, some coatings suitable for food contact that have exhibited good corrosion resistance have typically exhibited poor flexibility and unsuitable crazing when fabricated.

Accordingly, it will be appreciated that what is needed in the art are improved coating compositions that are made without intentionally using the above-described components or that are made such that these components are not retained in mobile form, but which exhibit the stringent balance of coating properties to permit the use of such coating compositions on food or beverage containers.

### SUMMARY

The present disclosure provides inventive vinyl resole phenolic resins for coating compositions, coating compositions, articles having a coating formed from such compositions, and methods of coating.

In one embodiment, a vinyl resole phenolic resin is provided that includes at least one resole group. The vinyl resole phenolic resin may optionally further include a liquid carrier.

In one embodiment, a coating composition is provided that includes: a vinyl resole phenolic resin including at least one resole group; a second polymer optionally, and preferably, including functional groups capable of undergoing a crosslinking reaction with the at least one resole group of the vinyl resole phenolic resin; an optional liquid carrier, an optional catalyst, an optional additional crosslinker, and/or an optional additional polymer. In some embodiments, the second polymer may be a polyester (such as, for example, a polyester urethane), a polyether, an acrylic, a polyolefin, an epoxy, and combinations and/or copolymers thereof. In certain embodiments, the second polymer is present in a majority amount (greater than 50 wt % second polymer), based on the total nonvolatile weight of the second polymer and the vinyl resole phenolic resin, although there are embodiments in which there may be little or no second polymer distinct from the vinyl resole phenolic resin.

In another aspect, the invention provides a coating composition useful for coating a wide variety of articles, including food or beverage containers. Certain preferred coating compositions of the invention are particularly useful as food-contact coatings for use on surfaces of metal food or beverage containers. The coating composition typically includes a vinyl resole phenolic resin including at least one resole group, a second polymer optionally, and preferably, including functional groups capable of undergoing a crosslinking reaction with the resole group of the vinyl resole phenolic resin, and an optional carrier.

In yet another aspect, the invention provides an article coated on at least one surface with a coating composition described herein. In certain embodiments, the coated article comprises a food or beverage container, or a portion thereof, having a body portion and/or end portion coated with a coating composition of the invention.

In yet another aspect, the invention provides a method for producing a coated article. The method includes providing a coating composition described herein and applying the coating composition on a substrate (typically a planar metal substrate) prior to, or after, forming the substrate into an article such as food or beverage container or a portion thereof.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the description below. Other features, objects, and advantages of the invention will be apparent from the description and from the claims.

### BRIEF DESCRIPTION OF THE DRAWINGS

For the purpose of illustrating aspects of the invention, exemplary forms of the invention are shown, it being understood however, that the invention is not limited to the precise forms shown by the drawings in which:

FIG. 1A illustrates a schematic diagram depicting an exemplary process for forming the vinyl resole phenolic resin described herein; and

FIG. 1B illustrates a schematic diagram depicting an exemplary process for forming the vinyl resole phenolic resin described herein.

### SELECTED DEFINITIONS

Unless otherwise specified, the following terms as used herein have the meanings provided below.

Unless otherwise indicated, a reference to a “(meth)acrylate” compound (where “meth” is bracketed) is meant to include both acrylate and methacrylate compounds.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “cyclic group” means a closed ring hydrocarbon group that is classified as an alicyclic group or an aromatic group, both of which can include heteroatoms.

A group that may be the same or different is referred to as being “independently” something. Substitution is anticipated on the organic groups of the compounds of the present disclosure. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

The term “component” refers to any compound that includes a particular feature or structure. Examples of components include compounds, monomers, oligomers, polymers, and organic groups contained there.

The term “ethylenically unsaturated” refers to compounds that include a non-aromatic carbon-carbon double bond (i.e. —C═C—), with vinylic double bonds being preferred.

The term “phenolic hydroxyl” refers to a hydroxyl moiety as bonded to a phenolic ring, with no intervening carbon atoms between the oxygen of the hydroxyl and the carbon of the phenolic ring. The term “protected phenolic hydroxyl” refers to a phenolic hydroxyl functional group wherein the hydrogen has been replaced with an organic group, such as, for example, a linear or branched, alkyl or substituted alkyl, protecting group.

The term “substantially free” of a particular mobile compound means that the compositions of the invention contain less than 100 parts per million (ppm) of the recited mobile compound. The term “essentially free” of a particular mobile compound means that the compositions of the invention contain less than 10 ppm of the recited mobile compound. The term “essentially completely free” of a particular mobile compound means that the compositions of the invention contain less than 1 ppm of the recited mobile compound. The term “completely free” of a particular mobile compound means that the compositions of the invention contain less than 20 parts per billion (ppb) of the recited mobile compound.

If the aforementioned phrases are used without the term “mobile” (e.g., “substantially free of XYZ compound”) then the compositions of the present disclosure contain less than the aforementioned amount of the compound whether the compound is mobile in the coating or bound to a constituent of the coating.

The term “mobile” means that the compound can be extracted from the cured coating when a coating (typically ~1 milligram per square centimeter (mg/cm²) (6.5 mg/in²) thick) is exposed to a test medium for some defined set of conditions, depending on the end use. An example of these testing conditions is exposure of the cured coating to HPLC-grade acetonitrile for 24 hours at 25° C.

The term “food-contact surface” refers to a surface of an article (e.g., a food or beverage container) that is in contact with, or suitable for contact with, a food or beverage product. When used in the context of a coating composition applied on a food-contact surface of a packaging article (e.g., a food or beverage container), the term refers to the underlying substrate (typically associated with an interior surface of the packaging article) on which the coating composition is applied and does not imply that the underlying portion of the substrate will be in contact with a food or beverage product.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the terms “polymer” and “polymeric material” include, but are not limited to, homopolymers, copolymers, such as for example, block, graft, random or statistical and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “monomer constituent unit” refers to the structural unit resulting from polymerization of monomers.

The term “unsaturation” when used in the context of a compound refers to a compound that includes at least one non-aromatic carbon-carbon double or triple bond.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “or” is generally employed in its usual sense including “and/or” unless the content clearly dictates otherwise.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In an aspect, the present disclosure provides a vinyl resole phenolic resin that is useful in coating compositions, and particularly coating compositions for coating food or beverage containers, articles having a coating formed from such compositions, and methods of coating. Herein, a food or beverage “container” is used to encompass containers for food or beverage products such as metal beverage cups (e.g., the tapered recycled aluminum cups described in U.S. Pat. No. 10,875,076), metal food drums in additional to conventional food or beverage cans and metal closures for glass food or beverage containers.

In one embodiment, a food or beverage container coating composition is provided that includes: a second polymer; and a vinyl resole phenolic resin (distinct from the second polymer). In certain embodiments, the second polymer is present in a majority amount (greater than 50 wt % second polymer), based on the total weight of the second polymer and the vinyl resole phenolic resin, although there are embodiments in which there may be little or no second polymer distinct from the vinyl resole phenolic resin. The mere usage of the term “second polymer” herein should not be construed to imply that the vinyl resole phenolic resin has any particular molecular weight.

### Vinyl Resole Phenolic Resin

The vinyl resole phenolic resin includes the reaction product of components including at least vinyl monomers including phenolic or protected phenolic groups, wherein the phenolic groups (or protected phenolic groups, following deprotection) are substituted with a methylol or methylol ether group to provide resole functionality. Preferably, the vinyl resole phenolic resin is a crosslinker. As used herein, “crosslinker” refers to molecules capable of forming a covalent linkage between polymers or between two different regions of the same polymer. It may also refer to self-crosslinking that can occur between different parts of the same vinyl resole phenolic resin molecule.

The resole phenolic resin of the present disclosure is a vinyl resin with resole functionality as opposed to either a conventional phenolic resole or a novolac phenolic resin, each of which are typically formed via reaction of a phenol compound with formaldehyde under particular reaction conditions. Generally, the inventive vinyl resole phenolic resin may be formed, in exemplary embodiments, by first forming a vinyl resin from an ethylenically unsaturated monomer component that includes a vinyl phenolic monomer (for example, a hydroxy styrene monomer), optionally in combination with one or more other ethylenically unsaturated monomers, and then adding resole functionality onto the monomer constituent unit provided by the vinyl phenolic monomer using a suitable methylolation process (e.g., via base-catalyzed methylolation; some suitable base catalysts include but are not limited to dimethylethanolamine, 1,5-diazabicyclo(4,3,0)non-5-ene (“DBN”), 1,5-diazabicyclo(4,3,0)non-7-ene (“DBU”), and NaOH). The term “vinyl resin” as used herein refers to a polymerization product such as an oligomer or polymer prepared by addition polymerizing (e.g., free radical polymerizing with the assistance of an initiator) an ethylenically unsaturated monomer component (e.g., a mixture of ethylenically unsaturated monomers and/or oligomers). Both conventional resole phenolic resins and novolac phenolic resins are not formed from vinyl monomers, and are not vinyl resins, nor does either include any such polymerization step. A conventional resole phenolic resin is distinguished from a novolac phenolic resin as a result of distinct formation reaction conditions (e.g., ratio of reactants and catalyst). A conventional resole phenolic resin is a base-catalyzed resin with an aldehyde (typically, formaldehyde) to phenol group-containing compound molar ratio of greater than one (e.g., 1.5). In contrast, a novolac phenolic resin is an acid-catalyzed resin with an aldehyde (typically, formaldehyde) to phenol group-containing compound molar ratio of less than one.

Preferred vinyl resole phenolic resins of the present disclosure have a backbone (e.g., longest chain) that is comprised of carbon-carbon single bonds due to the addition polymerization used to form the vinyl resin from an ethylenically unsaturated monomer component. In contrast, conventional resole and novolac phenolic resins formed from reactants including a phenol compound (e.g., phenol, BPA, BPF, and the like) have backbones that include aromatic groups. Preferred vinyl resole phenolic resins of the present disclosure have a backbone (e.g., longest chain) that is free of formaldehyde or structures derived from formaldehyde.

In preferred embodiments, the vinyl resole phenolic resin may first be partially formed as the polymerization product of an ethylenically unsaturated monomer component including one or more monomers having a phenolic or protected phenolic group. Preferred vinyl resole phenolic resins include a plurality of such groups. The phenolic groups of the polymerization product (or protected phenolic groups, following deprotection, typically with the application of an acid) are preferably subsequently substituted with a methylol or methylol ether group, which is believed to provide a resole capable of entering into a crosslinking reaction with other such vinyl resole phenolic resins, other regions of the same vinyl resole phenolic resin, or with a second polymer, such as, for example, a polyester polymer, an acrylic polymer, or an epoxy polymer. In preferred embodiments, the methylol or methylol ether group is attached at either the ortho- or the para-position of the phenolic ring of at least a portion of the phenolic groups of the vinyl resole phenolic resin relative to each phenolic hydroxyl of the phenolic groups.

In embodiments, the vinyl resole phenolic resin is the reaction product of monomers including monomers comprising one or more phenolic or protected phenolic groups and optional, other monomers, wherein the other monomers comprise ethylenically unsaturated monomers. The one or more phenolic groups (or protected phenolic groups, following deprotection, typically with the application of an acid) of the reaction product are further substituted with a methylol or methylol ether group to provide resole functionality (adding a resole-type alcohol or ether on at least one of the phenolic groups) and the vinyl resole phenolic resin. Exemplary methylol and methylol ether groups are formaldehyde or another alkyl or substituted alkyl aldehyde, or are derived from formaldehyde or another alkyl or substituted alkyl aldehyde.

The molecular weight of the vinyl resole phenolic resin of the invention can vary depending upon material choice and the desired end use. In preferred embodiments, the vinyl resole phenolic resin has a number average molecular weight (Mn) of at least about 500, more preferably at least about 800, more preferably at least about 1,000, more preferably at least about 1,500, and even more preferably at least about 3,000. Preferably, the Mn of the vinyl resole phenolic resin is less than about 500,000, more preferably less than about 100,000, more preferably less than about 20,000 more preferably less than about 15,000, more preferably less than about 10,000, and even more preferably less than about 8,000. The number=average molecular weight can be determined by gel permeation chromatography (GPC).

In embodiments, suitable monomers comprising one or more phenolic or protected phenolic groups further comprise ethylenic unsaturation allowing polymerization via free radical polymerization or cationic polymerization. Exemplary such monomers include p-hydroxystyrene (4-vinyl phenol), 4-acetoxystyrene, or p-tert-butyl hydroxystyrene monomers, and substituted variants thereof. In further embodiments, exemplary such monomers include 2-vinyl phenol and 3-vinyl phenol.

In embodiments, the optional other monomers included in the ethylenically unsaturated monomer component used to form the vinyl resole phenolic resin may separately, and preferably, include one or more ethylenically unsaturated monomers, such as, for example, (meth)acrylates s (e.g., alkyl, cycloalkyl, alkoxy, and aromatic (meth)acrylates), vinyl esters of saturated carboxylic acids, monoolefins, conjugated dienes, styrene, (meth)acrylamide, methylol (meth)acrylamide, styrene, α-methyl styrene, vinyl toluene, vinyl propionate, vinyl acetate, acrylonitrile, vinyl chloride (the use of halogen-containing monomers is not presently preferred), and the like. In an embodiment, the other monomers include one or more polyfunctional (meth)acrylate monomers. In some embodiments, the other monomers also include one or more ethylenically unsaturated carboxy-functional amide monomers, e.g., ureido-functional monomers, such as monomers formed as the product of the reaction between aminoalkyl alkylene urea (e.g., amino ethylene urea, for example) with an ethylenically unsaturated carboxylic acid or anhydride (e.g., maleic anhydride, for example). Examples of suitable (meth)acrylate and (meth)acrylic monomers include acrylic acid, methacrylic acid, methyl acrylate, ethyl acrylate, propyl acrylate, butyl acrylate, 2-ethylhexyl acrylate, cyclohexyl acrylate, benzyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxybutyl acrylate, hydroxybutyl methacrylate, cyclohexyl methacrylate (CHMA), glycidyl methacrylate, 4-hydroxybutyl acrylate glycidyl ether, allyl methacrylate, and mixtures thereof. Preferred monomers include styrene, methyl methacrylate, ethyl acrylate, methacrylic acid, n-butyl acrylate, tert-butyl acrylate, tert-butyl methacrylate, n-butyl methacrylate, esters of itaconic acid, vinyl acetate, 2-ethyl hexyl acrylate, CHMA, bio-based monomers, and the like. Suitable multi-ethylenically unsaturated monomers include polyfunctional acrylates such as, for example, di-, tri- and tetra-functional acrylates.

In further embodiments, the optional, other monomers may further include one or more bio-based monomers. “Bio-based,” as used with respect to monomers herein, refers to monomers that are preferably obtained from bio-renewable, ethylenically unsaturated monomers. Such bio-renewable ethylenically unsaturated monomers have a carbon-14 (C-14) content that is significantly higher than ethylenically unsaturated monomers derived from fossil fuels. C-14 has a relatively short half-life on the scale of the age of fossil-fuel-based materials, and so is present in lower amounts in fossil-fuel-based materials relative to bio-based materials. Thus, “bio-renewable” ethylenically unsaturated monomers as used herein mean monomers for which the level of C-14 isotope is comparable to the mean level of C-14 in atmospheric CO₂, as measured by ASTM D6866 or having at least about 1.5 dpm/gC (disintegrations per minute per gram carbon), at least 2.5 dpm/gC, or at least 3.0 dpm/gC of C-14, as measured through liquid scintillation counting.

Exemplary such bio-based monomers include esters of itaconic acid, bio-derived (meth)acrylic acid or its ester, and alkyl (meth)acrylic acid or its ester. In embodiments, bio-based monomers make up at least 10 wt %, at least 20 wt %, at least 30 wt %, or at least 40 wt % of the vinyl resole phenolic resin by weight of all monomers polymerized to form the vinyl resole phenolic resin.

Monomer constituent units need not be arranged in the vinyl resole phenolic resin in any particular order. The monomers of the vinyl resole phenolic resin may be polymerized such that the monomer constituent units are randomly distributed throughout (forming a statistical copolymer), in segmented or repeating blocks (block copolymer) or in other arrangements.

In preferred embodiments, the vinyl resole phenolic resin includes at least one monomer constituent unit having the structure of Formula I, shown below:

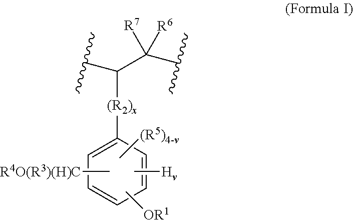

wherein R¹ is a hydrogen or an organic group including 1 to 20 carbon atoms, in further embodiments, 1 to 12 carbon atoms, in further embodiments 1 to 8 carbon atoms, and in still further embodiments, 1 to 4 carbon atoms; wherein R², if present, is an organic group including 1 to 6 carbon atoms, in further embodiments, 1 to 3 carbon atoms, and in still further embodiments, 1 to 2 carbon atoms; wherein each R³ is independently a hydrogen or an organic group including 1 to 10 carbon atoms, in further embodiments, 1 to 8 carbon atoms, in further embodiments 1 to 5 carbon atoms, and in still further embodiments, 1 to 2 carbon atoms; wherein each R⁴ is independently hydrogen or an organic group including from 1 to 4 carbon atoms, in further embodiments, 1 to 2 carbon atoms; wherein each R⁵ group is independently an alkoxy group, aryl group, aryl ether group, benzyl ether group, or an alternative organic group, each such component including from 1 to 20 carbon atoms, in further embodiments, 1 to 12 carbon atoms, in further embodiments 1 to 8 carbon atoms, and in still further embodiments, 1 to 4 carbon atoms; R⁶ and R⁷ are each independently hydrogen or an organic group such as, e.g., a branched or linear alkyl or substituted alkyl including 1 to 8 carbon atoms, in further embodiments, 1 to 6 carbon atoms, in further embodiments 1 to 4 carbon atoms, and in still further embodiments 1 to 2 carbon atoms; and wherein the subscript, v, ranges from 0 to 3. In preferred embodiments of Formula I, at least one —C(H)(R³)OR⁴ group is attached at either an ortho- or a para-position relative to the —OR¹ group. In further embodiments, R², if present, is an organic group that does not unacceptably diminish the reactivity of the resole group. In preferred embodiments, at least one of R⁶ and R⁷ is hydrogen, and if not hydrogen, is preferably not any group that would unacceptably diminish the reactivity of the resole group of the vinyl resole phenolic resin or inhibit polymerization required to form the vinyl resole phenolic resin. In certain preferred embodiments, both R⁶ and R⁷ are each hydrogen. Typically R¹ will be hydrogen, because R¹ will be deprotected. It is possible, though not presently preferred, to protect the phenolic hydroxyl again following synthesis of the vinyl resole phenolic resin. In further preferred embodiments, R¹ is located in the para position relative to the carbon of the phenolic ring linking the phenolic ring to the backbone of the vinyl resole phenolic resin, though R¹ can be located at any position on the phenolic ring that does not unacceptably diminish the reactivity of the resole group of the vinyl resole phenolic resin or inhibit polymerization required to form the vinyl resole phenolic resin. In preferred embodiments, the —OR¹ group attaches to the phenyl ring at an ortho or para position relative to the phenyl ring carbon atom at which the structure attaches to the vinyl resole phenolic resin backbone (i.e., the phenyl ring carbon atom closest to R², if present).

In some embodiments of the vinyl resole phenolic resin, monomers from which the one or more monomer constituent units having Formula I are derived make up at least about 20 wt %, in further embodiments, at least about 40 wt %, in further embodiments, at least about 50 wt %, in further embodiments, at least about 65 wt %, and in yet further embodiments, at least about 85 wt % of the total weight of all monomers polymerized to form the vinyl resole phenolic resin. In some embodiments of the vinyl resole phenolic resin, monomers from which the one or more monomer constituent units having Formula I are derived make up at most about 100 wt %, in further embodiments, at most about 95 wt %, in further embodiments, at most about 80 wt %, and in yet further embodiments, at most about 70 wt % of the total weight of all monomers polymerized to form the vinyl resole phenolic resin.

In some preferred embodiments, in addition to monomer constituent units having Formula I, the vinyl resole phenolic resin also includes one or more monomer constituent units derived from styrene, a (meth)acrylate, a (meth)acrylic acid, or mixtures thereof.

Monomer constituent units of the vinyl resole phenolic resin need not be arranged in any particular order. For example, the monomers of the vinyl resole phenolic resin may be polymerized such that their monomer constituent units are randomly distributed throughout (forming a random co-resin/copolymer), in segmented or repeating blocks (block co-resin/copolymer) or in other arrangements.

In some embodiments, the vinyl resole phenolic resin is at least partially formed as the polymerization reaction product of an ethylenically unsaturated monomer component including at least one monomer having the structure of Formula Ia, shown below:

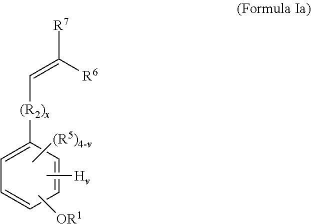

wherein each of R¹, R², R⁵, R⁶, R⁷, and x are as described above for Formula I. The subscript, v, can be any integer from zero to 4 for Formula Ia. For avoidance of doubt, the unreacted monomer having Formula Ia is not the disclosed, inventive vinyl resole phenolic resin. The methylol or methylol ether group of the formula —C(H)(R³)OR⁴ (from Formula I) replaces one of the hydrogens, Hv, or (R⁵)₄₋ᵥ groups of Formula Ia upon substitution.

In some embodiments, the vinyl resole phenolic resin includes monomer constituent units having the below Formula II.

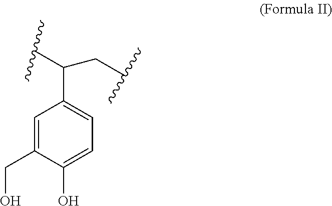 [SMILES: *CC(*)c1ccc(O)c(CO)c1]

In some embodiments of the vinyl resole phenolic resin, monomers from which the one or more monomer constituent units having Formula II are derived make up at least about 20 wt %, in further embodiments, at least about 40 wt %, in further embodiments, at least about 50 wt %, in further embodiments, at least about 65 wt %, and in yet further embodiments, at least about 85 wt % of the total weight of all monomers polymerized to form the vinyl resole phenolic resin. In some embodiments of the vinyl resole phenolic resin, monomers from which the one or more monomer constituent units having Formula II are derived make up at most about 100 wt %, in further embodiments, at most about 95 wt %, in further embodiments, at most about 80 wt %, and in yet further embodiments, at most about 70 wt % of the total weight of all monomers polymerized to form the vinyl resole phenolic resin.

In some embodiments, the vinyl resole phenolic resin is formed at least in part by cationic polymerization or by free radical polymerization.

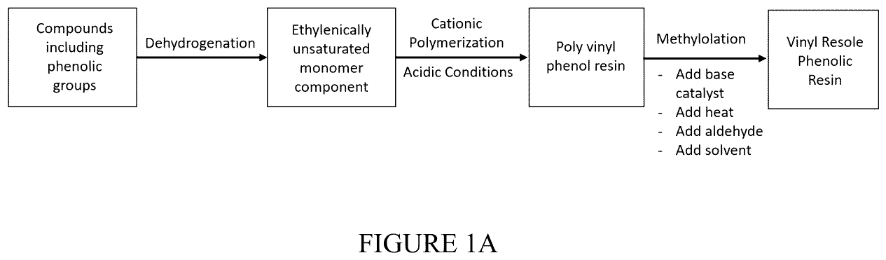

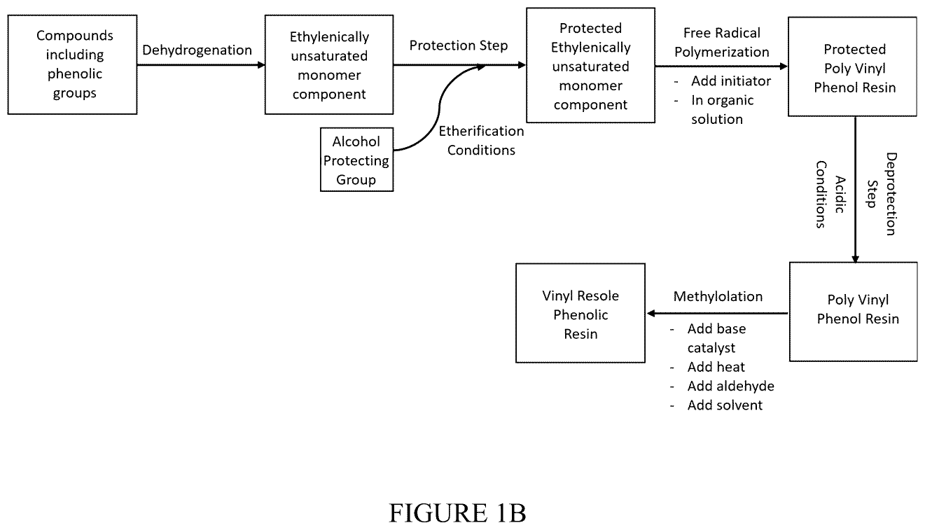

In some embodiments, the vinyl resole phenolic resin is formed at least in part by cationic polymerization. Exemplary methods for cationic polymerization of vinyl phenols may be accomplished according to methods described in U.S. Pat. No. 4,517,349, which is incorporated by reference herein in its entirety. In such embodiments, the subscript, x, is zero for monomer constituent units having the above-described Formulas I or II. Polymerization may occur all at once or in stages, with differing components added at the same, different, or overlapping times and at different rates. Compounds including phenolic groups may be dehydrogenated to provide ethylenically unsaturated monomers including the phenolic groups. These monomers including the phenolic groups are then polymerized along with any optional, other monomers via cationic polymerization, using an acid catalyst. The phenolic groups of the cationic polymerization product may then be subsequently provided with a methylol or methylol ether group to provide resole functionality. A schematic diagram conceptually demonstrating formation of the vinyl resole phenolic resin by an exemplary reaction pathway including a cationic polymerization step is shown in FIG. 1A.

In some embodiments, the vinyl resole phenolic resin is first partially formed by free radical polymerization of monomers including protected phenolic groups that are subsequently (following, or simultaneously with deprotection, for example, with the application of an acid deprotecting agent) substituted with a methylol or methylol ether group to provide resole functionality. While the deprotection step can, in some embodiments occur simultaneously with the substitution of a methylol or methylol ether group, it is presently preferred that deprotection occur prior to the substitution of the methylol or methylol ether group.

A schematic diagram conceptually demonstrating formation of the vinyl resole phenolic resin by an exemplary reaction pathway including a free radical polymerization step is shown in FIG. 1B.

In an exemplary embodiment, an exemplary, partially formed vinyl resole phenolic resin includes monomer constituent units having the below Formula IIa,

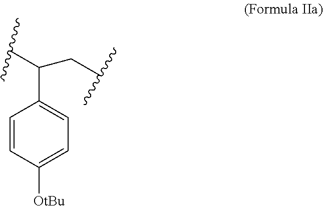 [SMILES: *CC(*)c1ccc(OC(C)(C)C)cc1]

The exemplary, partially formed vinyl resole phenolic resin including monomer constituent units having Formula IIa can be deprotected (with the application of a deprotecting agent, for example, an acid) and then substituted with a methylol or methylol ether group to provide resole functionality and the vinyl resole phenolic resin including monomer constituent units having the structure identified in Formula II, above. As shown in Formula IIa, “tBu” is an exemplary, tert-butyl, protecting group and can be replaced in other embodiments with other protecting groups.

In a preferred embodiment, the vinyl resole phenolic resin is first partially formed from monomers including protected phenolic-containing groups and optionally from other monomers via free radical polymerization. Without being bound by theory, it is believed that available or unprotected phenolic hydroxyl groups may interfere with free radical polymerization of vinyl monomers, thus inhibiting polymerization required to form the vinyl resole phenolic resin. It is believed that first protecting the phenolic hydroxyl of the unprotected phenolic groups allows the monomers including protected phenolic-containing groups to participate in free radical polymerization, allowing formation of the vinyl resole phenolic resin.

In some embodiments, monomers including available or unprotected phenolic hydroxyls are protected via the addition of an organic group including 1 to 20 carbon atoms, in further embodiments, 1 to 12 carbon atoms, in further embodiments 1 to 8 carbon atoms, and in still further embodiments, 1 to 4 carbon atoms, in place of at least a portion of the phenolic hydroxyl hydrogens. Exemplary protecting groups include tert-butyl protecting groups and acetal protecting groups. Exemplary methods for protecting styrene-type monomers may be accomplished according to methods described in Japanese Patent Application Publication No. JP2003252828A, which is incorporated by reference herein in its entirety.

In preferred embodiments, monomers including protected phenolic groups and optional, other monomers are polymerized via organic solution free radical polymerization.

In some embodiments, monomers including protected phenolic groups and optional, other monomers are polymerized via emulsion polymerization. In such embodiments, the resin formed therefrom may be a water-based resin for use in a water-based coating composition.

In some embodiments, the vinyl resole phenolic resin further includes a carrier. The carrier may be a liquid carrier. In preferred embodiments, the carrier is a liquid solvent that is capable of dissolving or dispersing the vinyl resole phenolic resin. In further preferred embodiments, the solvent is a protic solvent such as alcohols (e.g., butanol, carbitol) and glycols, cyclic or non-cyclic ethers such as tetrahydrofuran (THF), di(propylene glycol) dimethyl ether, or a mixture of isomers (for example, isomers of ether solvents as in CAS No. 111109-77-4), or mixtures thereof. In embodiments, the carrier liquid may include water.

In some embodiments, the vinyl resole phenolic resin is provided without a liquid carrier. It is contemplated that the vinyl resole phenolic resin of the invention may have utility when added as a solid or semisolid to a liquid coating composition or in other, non-liquid coating application techniques such as, for example, powder coating, extrusion coating, or lamination, where a liquid carrier may be unnecessary. In some embodiments, the vinyl resole phenolic resin is spray dried to form a powder, which can then be electrostatically applied to a substrate as described, for example, in U.S. Pat. No. 11,248,127, the entirety of which is herein incorporated by reference.

With the benefit of this disclosure, a person of ordinary skill in the art will recognize that the vinyl resole phenolic resin of the present invention will include fewer mobile components, including at least reduced mobile formaldehyde or phenols (i.e., free formaldehyde or phenols) as compared to conventional resole or novolac materials synthesized from aldehyde and phenolic raw materials.

In preferred embodiments, the vinyl resole phenolic resin compositions of the present invention include less than 10,000 ppm by weight as a percentage of the solids weight of the vinyl resole phenolic resin, in further embodiments less than 1000 ppm, in yet further embodiments, the vinyl resole phenolic resin is substantially free, more preferably essentially free, more preferably essentially completely free, and optionally completely free of each of or at least one of mobile formaldehyde (i.e., free formaldehyde), mobile phenols (i.e., free phenols), bisphenol A (“BPA”), bisphenol F (“BPF”), bisphenol S (“BPS”), and epoxides of BPA, BPF, and BPS.

In certain preferred embodiments, the vinyl resole phenolic resin of the invention is preferably substantially free, more preferably essentially free, even more preferably essentially completely free, and optimally completely free of each of or at least one of bound BPA, BPF, BPS, and epoxides of BPA, BPF, and BPS. In preferred embodiments, the ethylenically unsaturated monomer component used to make the vinyl phenolic resin does not include glycidyl acrylate or glycidyl methacrylate. In some embodiments, the vinyl phenolic resin does not include any oxirane functionality.

The vinyl phenolic resin is preferably not made using any halogenated monomers (e.g., vinyl chloride). More preferably, the vinyl phenolic resin does not include any halogen atoms.

### Second Polymer

Food or beverage container coating compositions of the present disclosure may further include a second polymer. A wide variety of second polymers typically used in the container coating industry can be used in the compositions of the present disclosure. These include, for example, polyethers, polyesters (including, e.g., polyester urethanes), acrylics, polyolefins, and combinations thereof (including copolymers thereof such as polyether-acrylics).

The second polymer is preferably not made using bisphenol A, bisphenol F, and bisphenol S or any reactants derived therefrom (e.g., the diglycidyl ether of bisphenol A “BADGE”). In some embodiments, the second polymer is not made using any bisphenols or any reactants derived therefrom.

In certain embodiments, the second polymer has a molecular weight (number average) of at least 2,000 Da, at least 3,000 Da, or at least 4,000 Da. In certain embodiments, the second polymer has a molecular weight (number average) of up to 20,000 Da, up to 10,000 Da, or up to 7,000 Da. The number-average molecular weight can be determined by gel permeation chromatography (GPC).

Examples of suitable polyether second polymers for use in coating compositions of the present disclosure include those that contain a plurality of aromatic ether segments. The polyether polymer may be formed, for example, from reactants including a polyhydric phenol group-containing compound (more typically a dihydric phenol group-containing compound) and a polyepoxide of a polyhydric phenol group-containing compound (more typically a diepoxide of a dihydric phenol group-containing compound). Such polyether second polymers may include one or more segments having one or more optionally substituted aryl or heteroaryl groups in a backbone portion of the segment. In some embodiments, the one or more such aryl or heteroaryl groups include one or more substituent groups (preferably “bulky” substituent groups) that are attached to the ring preferably at an ortho or meta position, more preferably an ortho position, relative to an oxygen atom attached to the ring, which is typically an oxygen atom of an ether or ester linkage, more typically an ether linkage. In some embodiments, the one or more segments include two or more aryl or heteroaryl groups in which at least two of the aryl or heteroaryl groups include an oxygen atom attached to the ring and a substituent group (preferably a “bulky” substituent group) attached to the ring preferably at an ortho or meta position relative to the oxygen atom. Non-limiting examples of such materials having ortho substituent groups include tetramethyl bisphenol F (TMBPF), diepoxides of TMBPF, and polymers formed therefrom. Examples of suitable such polymers are described in U.S. Pat. Pub. No. 2013/0316109 (Niederst et al.), herein incorporated by reference in its entirety.

In certain embodiments, the second polymer is a polyether (e.g., an aromatic polyether). In certain embodiments, the polyether second polymer has a Tg of greater than 70° C., or greater than 80° C. In certain embodiments, the polyether second polymer has a Tg of up to 150° C., or up to 110° C. In certain embodiments, the polyether second polymer is made from the reaction of a diepoxide of an ortho-substituted diphenol group-containing compound (e.g., the diglycidyl ether of tetra-methyl-bisphenol F) with an extender (e.g., a diphenol group-containing compound such as hydroquinone, or a diacid). Examples of suitable such polymers are described in U.S. Pat. Pub. No. 2013/0316109 (Niederst et al.). Examples of suitable polyether polymers (BPA free) are disclosed in U.S. Pat. No. 9,409,219 (Niederst et al.), U.S. Pat. Pub. No. 2013/0206756 (Niederst et al.), U.S. Pat. Pub. No. 2015/0021323 (Niederst et al.), International Pub. Nos. WO 2015/160788 (Valspar Sourcing), WO 2015/164703 (Valspar Sourcing), WO 2015/057932 (Valspar Sourcing), and WO 2015/179064 (Valspar Sourcing), each incorporated herein by reference in their entirety.

Examples of commercially available polyester second polymers that are suitable for use in coating compositions of the present disclosure include saturated polyesters available under the trade names DYNAPOL L, LH, and LS (Degussa AG, 45764 Marl, Germany), amorphous copolyesters available under the trade names VYLON GK330 and GK640 (Toyobo Co. Ltd., Osaka 530-8230, Japan), saturated thermoplastic polyesters available under the trade names SYNOLAC 75 NA 64 (medium molecular weight) and SYNOLAC 0691 S 60 (high molecular weight) (both available from Cray Valley, F-92091 Paris La Defense Cedex, France), alkyd type polyester resins, for example, those commercially available under the trade names URALAC AN621 S-2 60 and URALAC AN637 S-2 60 (available from DSM Neoresins BV, 5140 AC Waalwijk, Netherlands), and other polyesters available under the trade names DESMOPHEN T 1665 SN/IB and RUCOTE 552 (both available from Bayer Material Science AG, D-51368, Leverkusen, Germany) as well as URALAC SN800 S2G3-60, URALAC SN852 S2F-60, and URALAC SN859 S2G3-50 (all available from DSM Neoresins BV, 5140 AC Waalwijk, Netherlands).

Acrylic second polymers that are suitable for use in coating compositions of the present disclosure include the reaction products of a composition that includes a (meth)acrylic acid ester, an ethylenically unsaturated mono- or multi-functional acid, and an optional vinyl compound. For example, the acrylate second polymer could be a reaction product of components that include ethyl acrylate, acrylic acid, and styrene (preferably in the presence of 2,2′-azobis(2-methyl-butyronitrile) and tert-butyl peroxybenzoate free radical initiators).

Examples of suitable (meth)acrylic acid esters (i.e., methacrylic acid esters and acrylic acid esters) include methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isoamyl (meth)acrylate, hexyl (meth)acrylate, 2-hydroxyethyl (meth)acrylate, 2-ethylhexyl (meth)acrylate, cyclohexyl (meth)acrylate, decyl (meth)acrylate, isodecyl (meth)acrylate, benzyl (meth)acrylate, 2-hydroxypropyl (meth)acrylate, lauryl (meth)acrylate, isobornyl (meth)acrylate, octyl (meth)acrylate, and nonyl (meth)acrylate.

Examples of suitable ethylenically unsaturated mono- or multi-functional acids include methacrylic acid, acrylic acid, crotonic acid, itaconic acid, maleic acid, mesaconic acid, citraconic acid, sorbic acid, and fumaric acid.

Examples of suitable vinyl compounds include styrene, halostyrene, isoprene, a conjugated butadiene, alpha-methylstyrene, vinyl toluene, vinyl naphthalene, vinyl chloride, acrylonitrile, methacrylonitrile, vinyl acetate, vinyl propionate, vinyl cyclohexane, vinyl cyclooctane, vinyl cyclohexene, and vinyl stearate.

Examples of commercially available acrylic second polymers that are suitable for use in coating compositions of the present disclosure include those available under the trade names VIACRYL SC 454/50BSNB, VIACRYL SC383w/50WA, and VANCRYL 2900 DEV (all from Cytec Industries Inc., West Patterson, NJ), as well as NEOCRYL A-639, NEOCRYL XK-64, URACON CR203 M3, and URACON CS113 SIG (all from DSM Neoresins BV, 5140 AC Waalwijk, Netherlands). Examples of acrylic second polymers can be found in U.S. Pat. No. 7,592,047 (O'Brien) and U.S. Pat. No. 7,189,787 (O'Brien), each incorporated herein by reference in their entirety.

Examples of suitable polyolefin second polymers for use in coating compositions of the present disclosure include maleic-modified polyethylene, maleic-modified polypropylene, ethylene acrylic acid copolymers, ethylene methacrylic acid copolymers, propylene acrylic acid copolymers, propylene methacrylic acid copolymers, and ethylene vinyl alcohol copolymers.

Examples of commercially available polyolefin second polymers that are suitable for use in coating compositions of the present disclosure include those available under the trade names DOW PRIMACOR 5980i, DUPONT NUCREL, POLYBOND 1103, NIPPON SOARNOL (EVOH), ARKEMA OREVAC 18751, and ARKEMA OREVAC 18360. Examples of polyolefin second polymers can be found in U.S. Pat. No. 9,000,074 (Choudhery), U.S. Pat. No. 8,791,204 (Choudhery), and International Pub. No. WO 2014/140057 (Akzo Nobel) and U.S. Pat. No. 8,722,787 (Romick et al.), U.S. Pat. No. 8,779,053 (Lundgard et al.), and U.S. Pat. No. 8,946,329 (Wilbur et al.), each incorporated herein by reference in their entirety.

For aqueous coating compositions, preferred second polymers are polyether-acrylic second polymers, wherein the acrylate (i.e., acrylic) portion provides water-dispersing groups. In certain embodiments, the polyether-acrylic polymers are latex polymers.

### Container Coating Compositions

In another aspect, the invention is a coating composition that includes the inventive vinyl resole phenolic resin as described according to any embodiment of the vinyl resole phenolic resin disclosed herein. While non-food-contact coating compositions are within the scope of this invention, preferred coating compositions are packaging coating compositions suitable for use as food-contact coatings. The coating composition of the invention preferably includes the inventive vinyl resole phenolic resin as described according to any embodiment of the vinyl resole phenolic resin disclosed herein, a second polymer optionally, and preferably, capable of participating in a crosslinking reaction with the vinyl resole phenolic resin during coating cure, and an optional liquid carrier. The coating composition preferably also includes a catalyst (such as, e.g., an acid catalyst) to enhance curing and/or crosslinking. The coating composition may further include optional additional polymers, optional additional vinyl resole phenolic resins, and optional additional components. Although liquid carrier-based coating compositions are preferred, it is contemplated that the coating compositions of the invention may have utility in other coating application techniques such as, for example, powder coating, extrusion coating, or lamination. Preferred cured coatings of the invention exhibit a suitable balance of coating properties, including excellent chemical resistance, excellent fabrication properties, and good adhesion.

Coating compositions of the invention may include any suitable amount of inventive vinyl resole phenolic resin to produce the desired result. In preferred embodiments, the inventive coating compositions include at least about 1 wt. % of the vinyl resole phenolic resin, in further embodiments, at least about 5 wt. %, in further embodiments, at least about 10 wt. %, in still further embodiments, at least about 15 wt. % and in still further embodiments, at least about 20 wt. %, wherein wt. % is expressed as the nonvolatile vinyl resole phenolic resin content weight as a percentage of nonvolatile coating content weight. Preferably, the inventive coating compositions include at most about 95 wt. % of the vinyl resole phenolic resin, in further embodiments, at most about 75 wt. %, in further embodiments, at most about 50 wt. %, in still further embodiments, at most about 30 wt. % and in still further embodiments, at most about 20 wt. %, wherein wt. % is expressed as the nonvolatile vinyl resole phenolic resin content weight as a percentage of nonvolatile coating content weight. In certain embodiments, the vinyl resole phenolic resin is present in an amount of 100 wt. %, and there is no distinct second polymer. In such embodiments, the vinyl resole phenolic resin is both the film-former and the crosslinker (i.e., it self-crosslinks).

Coating compositions of the invention may include any suitable amount of second polymer to produce the desired result. In some embodiments, the coating compositions do not include any second polymer, and the vinyl resole phenolic resin is present to the exclusion of the second polymer. In preferred embodiments, the inventive coating compositions include at least 5 about wt. % of the second polymer, in further embodiments, at least about 25 wt. %, in further embodiments, at least about 50 wt. %, in still further embodiments, at least about 70 wt. % and in still further embodiments, at least about 80 wt. %, wherein wt. % is expressed as the nonvolatile second polymer content weight as a percentage of nonvolatile coating content weight. Preferably, the inventive coating compositions include at most about 99 wt. % of the second polymer, in further embodiments, at most about 90 wt. %, in further embodiments, at most about 80 wt. %, in still further embodiments, at most about 60 wt. % and in still further embodiments, at most about 50 wt. %, wherein wt. % is expressed as the nonvolatile second polymer content weight as a percentage of nonvolatile coating content weight.

Preferred coating compositions of the invention preferably include less than 10,000 ppm, more preferably less than 1000 ppm, or are, more preferably substantially free, more preferably essentially free, even more preferably essentially completely free, and optimally completely free of each of or at least one of mobile formaldehyde or phenols. In certain preferred embodiments, coating compositions of the invention are preferably substantially free, more preferably essentially free, even more preferably essentially completely free, and optimally completely free of BPA, BPF, BPS, and epoxides of BPA, BPS, and BPF. A person having ordinary skill in the art will recognize, with the benefit of this disclosure, that the coating compositions disclosed herein provide maintained or improved coating performance properties with reduced levels of mobile formaldehyde and phenols as compared to conventional coating compositions. In some embodiments, the coating compositions described herein include no intentionally added amount of BPA, BPF, BPS, and epoxides of BPA, BPS, and BPF. As a person having ordinary skill in the art will appreciate with the benefit of this disclosure, the coating compositions of this disclosure provide maintained or superior performance properties while being likely to generate less mobile formaldehyde during a bake cure process, as compared to conventional resole-containing coatings.

When present, the concentration of one or more optional, additional crosslinkers may vary depending upon the desired result. For example, in some embodiments, the coating compositions may contain from about 0.01 wt-% to about 40 wt-%, more preferably from about 0.5 wt-% to about 35 wt-%, or even more preferably from about 3 wt-% to about 30 wt-% of one or more crosslinkers, by weight of nonvolatile material in the coating composition.

Any suitable optional, additional crosslinker can be used. For example, amino crosslinkers (e.g., aminoplasts), blocked isocyanate crosslinkers, a beta-hydroxyalkylamide crosslinker, a carbodiimide crosslinker, materials including oxirane groups (e.g., oxirane-functional polyester such as glycidyl-modified polyesters or oxirane-functional vinyl polymers such as acrylic resins formed using glycidyl methacrylate) and combinations thereof, may be used.

The coating compositions of the present disclosure are presently preferred for food or beverage coating applications and, in particular, food-contact coatings. While not intending to be bound by any theory, cured packaging coatings formulated using the inventive vinyl resole phenolic resin of the invention (with or without optional additional polymers, other components, or crosslinkers such as, e.g., aminoplasts and/or blocked isocyanate) have been observed to exhibit superior coating properties (e.g., superior chemical resistance) relative to comparable coating compositions formulated with other types of crosslinker(s) (e.g., amino and/or blocked isocyanate alone without vinyl resole phenolic-type crosslinkers) or conventional polymer/resole crosslinker systems. In preferred embodiments, the vinyl resole phenolic resin is believed to form covalent bonds with hydroxyl groups of the second polymer during cure (e.g., thermal cure) of the coating composition to form a cured coating, resulting in the formation of a crosslinked polymer network including both the inventive vinyl resole phenolic resin and the second polymer. While not intending to be bound by any theory, this is believed to be responsible, at least in part, for the enhanced coating properties exhibited by certain preferred packaging coatings of the invention relative to conventional packaging coatings that do not form such a polymer network with each other.

The coating compositions may optionally include amino crosslinker resins (e.g., aminoplasts). Amino crosslinker resins are typically the condensation products of aldehydes (e.g., such as formaldehyde, acetaldehyde, crotonaldehyde, and benzaldehyde) with amino- or amido-group-containing substances (e.g., urea, melamine and benzoguanamine). Suitable amino crosslinking resins include, for example, benzoguanamine-formaldehyde-based resins, melamine-formaldehyde-based resins (e.g., hexamethonymethyl melamine), etherified melamine-formaldehyde, urea-formaldehyde-based resins, and mixtures thereof.

Condensation products of other amines and amides can also be employed such as, for example, aldehyde condensates of triazines, diazines, triazoles, guanadines, guanamines and alkyl- and aryl-substituted melamines. Some examples of such compounds are N,N′-dimethyl urea, benzourea, dicyandimide, formaguanamine, acetoguanamine, glycoluril, ammelin 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. While the aldehyde employed is typically formaldehyde, other similar condensation products can be made from other aldehydes, such as acetaldehyde, crotonaldehyde, acrolein, benzaldehyde, furfural, glyoxal and the like, and mixtures thereof.

Suitable commercially available amino crosslinking resins include, for example, CYMEL 301, CYMEL 303, CYMEL 370, CYMEL 373, CYMEL 1131, CYMEL 1125, and CYMEL 5010 Maprenal MF 980 (all available from Cytec Industries Inc., West Patterson, NJ) and Uramex BF 892 (available from DSM, Netherlands).

One preferred optional ingredient is a catalyst to increase the rate of cure and/or the extent of crosslinking. The catalyst is typically chosen from among the catalysts known for use in the crosslinking of resole type phenolic resin and/or the electrophilic substitution of aromatic rings. Examples of such catalysts, include but are not limited to, strong acids (e.g., dodecylbenzene sulphonic acid (DDBSA), available as CYCAT 600 from Cytec), methane sulfonic acid (MSA), p-toluene sulfonic acid (pTSA), dinonylnaphthalene disulfonic acid (DNNDSA), sulfuric acid, triflic acid, phosphoric acid, and mixtures thereof and bases (e.g., dimethylethanolamine, 1,5-diazabicyclo(4,3,0)non-5-ene (“DBN”), 1,5-diazabicyclo(4,3,0)non-7-ene (“DBU”), and NaOH).

If used, a catalyst is preferably present in an amount of at least 0.01 wt %, and more preferably at least 0.1 wt %, based on the weight of nonvolatile material. If used, a catalyst is preferably present in an amount of no greater than 3 wt %, and more preferably no greater than 1 wt %, based on the weight of nonvolatile material.

If desired, coating compositions of the invention may optionally include other additives that do not adversely affect the coating composition or a cured coating resulting therefrom. The optional additives are preferably at least substantially free of mobile formaldehyde and phenol and mobile and/or bound BPA, and are more preferably completely free of BPA. Suitable additives include, for example, those that improve the processability or manufacturability of the composition, enhance composition aesthetics, or improve a particular functional property or characteristic of the coating composition or the cured composition resulting therefrom, such as adhesion to a substrate. Additives that may be included are carriers, additional polymers, emulsifiers, pigments, metal powders or paste, fillers, anti-migration aids, anti-microbials, extenders, curing agents, lubricants, coalescents, wetting agents, biocides, plasticizers, crosslinking agents, antifoaming agents, colorants, waxes, anti-oxidants, anticorrosion agents, flow control agents, thixotropic agents, dispersants, adhesion promoters, UV stabilizers, scavenger agents or combinations thereof. Each optional ingredient can be included in a sufficient amount to serve its intended purpose, but preferably not in such an amount to adversely affect a coating composition or a cured coating resulting therefrom.

Any suitable carrier may be used to prepare coating compositions of the invention. Suitable carriers include carrier liquids such as organic solvents, water, and mixtures thereof. Suitable organic solvents include aliphatic hydrocarbons (e.g. mineral spirits, kerosene, high flashpoint VM&P naptha, and the like); aromatic hydrocarbons (e.g. benzene, toluene, xylene, solvent naphtha 100, 150, 200 and the like); alcohols (e.g. ethanol, n-propanol, isopropanol, n-butanol, iso-butanol and the like); ketones (e.g. acetone, 2-butanone, cyclohexanone, methyl aryl ketones, ethyl aryl ketones, methyl isoamyl ketones, and the like); esters (e.g. ethyl acetate, butyl acetate and the like); glycols (e.g. butyl glycol), glycol ethers (e.g. ethylene glycol monomethyl ether, ethylene glycol monoethyl ether, ethylene glycol monobutyl ether, propylene glycol monomethyl ether, and the like); glycol esters (e.g. butyl glycol acetate, methoxypropyl acetate and the like); cyclic or non-cyclic ethers (e.g., mixtures of isomers of ethers (e.g., CAS No. 111109-77-4), THF, di(propylene glycol) dimethyl ether, and the like); and mixtures thereof. Preferably, the liquid carrier(s) are selected to provide a dispersion or solution of the vinyl resole phenolic resin of the invention for further formulation.

In some embodiments, the coating composition of the invention is a water-based varnish. In some such embodiments, preferably at least about 50 wt % of the liquid carrier system is water, more preferably at least about 60 wt % is water, and even more preferably at least about 75 wt % is water. Certain coating compositions of the invention include at least about 10 wt % of water, more preferably at least about 20 wt % of water, and even more preferably at least about 40 wt % of water (in some embodiments about 50 wt % or more of water), based on the total weight of the coating composition.

Coating compositions of the invention may be prepared by conventional methods in various ways. For example, the coating compositions may be prepared by simply admixing the vinyl resole phenolic resin or the vinyl resole phenolic resin and a second polymer, and any other optional ingredients, in any desired order, with sufficient agitation. The resulting mixture may be admixed until all the composition ingredients are substantially homogeneously blended. Alternatively, the coating compositions may be prepared as a liquid solution or dispersion by admixing an optional carrier liquid, the vinyl resole phenolic resin or the vinyl resole phenolic resin and the second polymer, and any other optional ingredients, in any desired order, with sufficient agitation. An additional amount of carrier liquid may be added to the coating compositions to adjust the amount of nonvolatile material in the coating composition to a desired level.

The total amount of solids present in coating compositions of the invention may vary depending upon a variety of factors including, for example, the desired method of application. Presently preferred coating compositions include at least about 19, more preferably at least about 20, more preferably at least about 30, more preferably at least about 35, and even more preferably at least about 40 wt % of solids, based on the total weight of the coating composition. Preferably, the coating compositions include less than about 80, more preferably less than about 70, and even more preferably less than about 65 wt % of solids, based on the total weight of the coating composition.

In another embodiment, the invention provides a coating composition that includes the vinyl resole phenolic resin of the invention in combination with an optional thermoplastic dispersion and optional other components. Such coating compositions may be suitable for various applications such as, for example, food or beverage packaging applications. While not intending to be bound by any theory, it is believed that certain vinyl resole phenolic resins and second polymer combinations of the invention are capable of stabilizing certain thermoplastic materials such as, for example, poly vinyl chloride (“PVC”) to prevent or decrease degradation of the thermoplastic material or a cured coating resulting therefrom. Thus, it is within the scope of this invention to include an efficacious amount of the vinyl resole phenolic resin and second polymer of the invention (e.g., for purposes of stabilizing the thermoplastic dispersion) in an organosol or plastisol coating composition. Organosols useful in the compositions of the invention, include, for example, vinyl organosols. A “vinyl organosol,” as used herein, is a dispersion of vinyl chloride polymers (preferably high-molecular-weight vinyl chloride polymers) in a liquid carrier. A discussion of suitable materials and preparation methods for such compositions may be found, for example, in U.S. Pat. App. No. PCT/US2008/058899.

Organosol coating compositions of the invention preferably include at least about 10, more preferably at least about 15, and even more preferably at least about 20 wt % of the second polymer, based on the total nonvolatile weight of the coating composition. The organosol coating compositions preferably include less than about 90, more preferably less than about 70, and even more preferably less than about 60 wt % of the second polymer, based on the total nonvolatile weight of the coating composition.

Organosol coating compositions of the invention preferably include at least about 10, more preferably at least about 15, and even more preferably at least about 20 wt % of thermoplastic material, based on the total nonvolatile weight of the coating composition. The organosol coating compositions preferably include less than about 80, more preferably less than about 70, and even more preferably less than about 65 wt % of thermoplastic material, based on the total nonvolatile weight of the coating composition.

The concentration of vinyl resole phenolic resin in the organosol coating compositions of the invention may vary depending upon the desired result. For example, in some embodiments, the organosol coating composition includes vinyl resole phenolic resin in an amount of preferably at least about 0.5, more preferably at least about 1, and even more preferably at least about 4.5 wt %, by weight of nonvolatile material in the coating composition. The amount of vinyl resole phenolic resin included in the coating composition is preferably less than about 15, more preferably less than about 7, and even more preferably less than about 5 wt %, by weight of nonvolatile material in the coating composition.

Examples of suitable thermoplastic materials include halogenated polyolefins, which include, for example, copolymers and homopolymers of vinyl chloride, vinylidenefluoride, polychloroprene, poly chloroisoprene, polychlorobutylene, and combinations thereof. PVC is a particularly preferred thermoplastic material. The thermoplastic material preferably has a number average molecular weight (Mn) of from about 40,000 to about 300,000; more preferably from about 75,000 to about 200,000; and even more preferably from about 100,000 to about 150,000.

In applications involving packaging coatings, dispersion grade thermoplastic particles are preferred, where the particles range in size from greater than 0 to about 5 microns, based on volume-average median particle diameter. Other sizes, however, can be used such as, for example, non-dispersion grade thermoplastic particles that range in size from about 5 to about 100 microns, based on volume-average median particle diameter.

The thermoplastic material is preferably dispersed in a liquid carrier to form a thermoplastic dispersion. Examples of suitable liquid carriers include an organic solvent, a plasticizer, or mixtures thereof. Suitable organic solvents may include polar solvents such as ketones (e.g., MIBK and DIBK), glycol ethers, alcohols, aliphatic hydrocarbons, aromatic hydrocarbons, or mixtures thereof. In some embodiments, it may be advantageous to choose a solvent that has an affinity to the thermoplastic material and/or one that can swell the thermoplastic particles to facilitate storage stability of the liquid coating composition. Preferred liquid carriers exhibit sufficient volatility to substantially evaporate from the coating composition during the curing process.

Cured coatings of the invention preferably adhere well to metal (e.g., steel, tin-free steel (TFS), tin plate, electrolytic tin plate (ETP), aluminum, etc.) and provide high levels of resistance to corrosion or degradation that may be caused by prolonged exposure to products such as food or beverage products. The coatings may be applied to any suitable surface, including inside surfaces of containers, outside surfaces of containers, container ends, and combinations thereof.

The coating composition of the invention can be applied to a substrate using any suitable procedure such as spray coating, roll coating, coil coating, curtain coating, immersion coating, meniscus coating, kiss coating, blade coating, knife coating, dip coating, slot coating, slide coating, and the like, as well as other types of premetered coating. In one embodiment where the coating is used to coat metal sheets or coils, the coating can be applied by roll coating.

The coating composition can be applied on a substrate prior to, or after, forming the substrate into an article. In some embodiments, at least a portion of a planar substrate is coated with one or more layers of the coating composition of the invention, which is then cured before the substrate is formed into an article.

After applying the coating composition onto a substrate, the composition can be cured using a variety of processes, including, for example, oven baking by either conventional or convectional methods. The curing process may be performed in either discrete or combined steps. For example, the coated substrate can be dried at ambient temperature to leave the coating composition in a largely un-crosslinked state. The coated substrate can then be heated to fully cure the coating composition. In certain instances, the coating composition can be dried and cured in one step. In preferred embodiments, the coating composition of the invention is a heat-curable coating composition.

The curing process may be performed at any suitable temperature, including, for example, temperatures in the range of about 180° C. to about 250° C. If metal coil is the substrate to be coated, curing of the applied coating composition may be conducted, for example, by subjecting the coated metal to a temperature of about 230° C. to about 250° C. for about 15 to 30 seconds. If metal sheeting is the substrate to be coated (e.g., such as used to make three-piece food cans), curing of the applied coating composition may be conducted, for example, by subjecting the coated metal to a temperature of about 190° C. to about 210° C. for about 8 to about 12 minutes.

The coating compositions of the present disclosure preferably have a viscosity suitable for a given coating application. Although various application methods are useable, the coating compositions may have a viscosity suitable for spray coating. In further embodiments, the coating compositions have a viscosity of at least about 25 centipoise (cps) (25 mPas), in further embodiments at least about 50 mPas, in further embodiments at least about 150 mPas, in further embodiments at least about 500 mPas, and in still further embodiments, at least about 750 mPas. In further embodiments, the coating compositions have a viscosity of at most about 5000 mPas, in further embodiments at most about 4000 mPas, in further embodiments at most about 3000 mPas, and in still further embodiments, at most about 2000 mPas.

The coating compositions of the present disclosure may be thermally curable. In this context, thermally curable refers to conditions of temperature and time usually used in container coating lines. In this regard the particular temperature and time ranges are oven temperatures or “PMT” (peak metal temperatures).

In certain embodiments, a food or beverage container coating composition of the present disclosure is thermally curable at a temperature of at least 176° C., or at least 190° C. In certain embodiments, a food or beverage container coating composition of the present disclosure is thermally curable at a temperature of up to 250° C., or up to 235° C.

In certain embodiments, a food or beverage container coating composition of the present disclosure is thermally curable in at least 10 seconds, at least 20 seconds, or in at least 30 seconds. In certain embodiments, a food or beverage container coating composition of the present disclosure is thermally curable within a period of up to 30 minutes, or up to 20 minutes, or up to 10 minutes, or up to 5 minutes.

Coating compositions of the invention may be useful in a variety of coating applications. The coating compositions are particularly useful as adherent coatings on interior or exterior surfaces of metal containers. Examples of such articles include closures (including, e.g., internal surfaces of twist off caps for food and beverage containers); internal crowns; two- and three-piece cans (including, e.g., food and beverage containers); shallow drawn cans; deep drawn cans (including, e.g., multi-stage draw and redraw food cans); can ends (including, e.g., easy open can ends); monobloc aerosol containers; and general industrial containers, cans, and can ends.

Coating compositions of the invention may be suited for use on interior or exterior surfaces of metal food or beverage containers, including food-contact surfaces. In embodiments, the cured coatings are retortable when employed in food and beverage container applications. In embodiments, cured coatings of the invention are capable of withstanding elevated temperature conditions frequently associated with retort processes or other food or beverage preservation or sterilization processes. Particularly preferred cured coatings exhibit enhanced resistance to such conditions while in contact with food or beverage products that exhibit one or more aggressive (or corrosive) chemical properties under such conditions. Examples of such aggressive food or beverage products may include meat-based products, milk-based products, fruit-based products, energy drinks, and acidic or acidified products.

In further embodiments, coating compositions of the invention are suited for use on the surfaces of containers for household products, such as paint cans, aerosol containers, steel containers, and other containers.

In some embodiments, the coating composition of the invention is suitable for use as a coating on the food-contact surface of the sidewall of a three-piece food can. The coating composition is typically applied to a metal sheet which is then typically cured prior to fabricating the coated sheet into the sidewall of a three-piece food can.

In some embodiments, the coating compositions of the present disclosure are storage stable. As contemplated herein, a coating composition that is “storage stable” means that, when all components of the coating composition are mixed and stored prior to application to a substrate, the coatings compositions will retain their ability during storage (for at least a certain amount of storage time) to be applied onto a substrate and then cure, following application. In preferred embodiments, the coating composition is storage stable for at least 20 days, in further embodiments for at least one month, in further embodiments for at least 3 months, and in yet further embodiments for at least 6 months.

Use of coating compositions of the present disclosure include: providing a coating composition as described herein; applying the coating composition to at least a portion of a metal substrate prior to or after forming the metal substrate into a food or beverage container (e.g., a can) or portion thereof; and thermally curing the coating composition.

In certain embodiments of such methods, the metal substrate includes a steel or aluminum substrate. In certain embodiments of such methods, the coating composition is applied to a preformed food or beverage container or a portion thereof. That is, in certain embodiments, the metal substrate is in the form of a preformed food or beverage container having a sidewall and a bottom end, and spraying comprises spraying an interior surface of the sidewall and bottom end.

In certain embodiments of such methods, the coating composition is applied to a food- or beverage-contact surface of the metal substrate (e.g., an interior side of a food or beverage container or a surface that will become an interior side of a food or beverage container). Thus, methods of the present disclosure can involve applying the coating composition to a flat substrate, and then forming the flat metal substrate into at least a portion of a food or beverage container after thermally curing the coating composition.

In certain embodiments of such methods, applying the coating composition includes applying the coating composition on the metal substrate in an amount sufficient to form a cured coating having an average dry film weight of 1 mg/in² (i.e., 1.55 g/m²) to 20 mg/in² (i.e., 31 g/m²).

The disclosed coating compositions may be applied to a substrate either prior to, or after, the substrate is formed into an article such as, for example, a food or beverage container or a portion thereof. In one embodiment, a method of forming food or beverage containers is provided that includes: applying (via spray application, dipping, etc.) a coating composition described herein to a metal substrate (e.g., applying the composition to the metal substrate in the form of a planar coil or sheet), thermally curing the coating composition, and forming (e.g., via stamping) the substrate into a packaging container or a portion thereof (e.g., a food or beverage container or a portion thereof). For example, two-piece or three-piece cans or portions thereof such as riveted beverage can ends (e.g., soda or beer cans) with a cured coating of the disclosed coating composition on a surface thereof can be formed in such a method.

### ILLUSTRATIVE EMBODIMENTS

Embodiment 1 is a vinyl resole phenolic resin for a coating composition, the vinyl resole phenolic resin comprising at least one monomer constituent unit having the below Formula I.

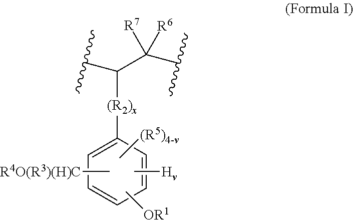

wherein each R^{F} is independently a hydrogen or an organic group including 1 to 20 carbon atoms; wherein each R², if present, is independently an organic group having 1 to 3 carbon atoms; wherein the subscript, x, is either zero or 1; wherein each R³ is independently a hydrogen or an organic group including 1 to 10 carbon atoms; wherein each R⁴ is independently hydrogen or an organic group including from 1 to 4 carbon atoms; wherein each R⁵ group is independently an alkoxy group, aryl group, aryl ether group, benzyl ether group, or an alternative organic group, each such component including from 1 to 20 carbon atoms; wherein R⁶ and R⁷ are each independently hydrogen or an organic group including 1 to 8 carbon atoms; and wherein the subscript, v, ranges from 0 to 3.

Embodiment 2 is the vinyl resole phenolic resin of any preceding embodiment, wherein the vinyl resole phenolic resin has a Mn of at least about 500, at least about 800, at least about 1,000, at least about 1,500, or at least about 3,000.

Embodiment 3 is the vinyl resole phenolic resin of any preceding embodiment, wherein the vinyl resole phenolic resin has a Mn of less than about 500,000, less than about 100,000, less than about 20,000, less than about 15,000, less than about 10,000, or less than about 8,000.

Embodiment 4 is the vinyl resole phenolic resin of any preceding embodiment, wherein the vinyl resole phenolic resin is a random copolymer.

Embodiment 5 is the vinyl resole phenolic resin of any preceding embodiment, wherein the vinyl resole phenolic resin further includes a carrier.

Embodiment 6 is the vinyl resole phenolic resin of the immediately preceding embodiment, wherein the carrier is a liquid carrier.

Embodiment 7 is the vinyl resole phenolic resin of the immediately preceding embodiment, wherein the carrier is selected from a protic solvent such as alcohols (e.g., butanol, carbitol) and glycols, water, cyclic or non-cyclic ethers (such as tetrahydrofuran (THF), di(propylene glycol) dimethyl ether, a mixture of isomers (for example, isomers of ether solvents as in CAS No. 111109-77-4), and the like), and mixtures thereof.

Embodiment 8 is the vinyl resole phenolic resin of any of embodiments 1 to 4, wherein the vinyl resole phenolic resin is spray dried to form a powder.

Embodiment 9 is the vinyl resole phenolic resin of any preceding embodiment, wherein the vinyl resole phenolic resin is at least partially formed by free radical or cationic polymerization.

Embodiment 10 is the vinyl resole phenolic resin of any preceding embodiment, wherein each R⁶ and R⁷ is independently hydrogen or an organic group having 1 to 6 carbon atoms, 1 to 4 carbon atoms, or 1 to 2 carbon atoms.

Embodiment 11 is the vinyl resole phenolic resin of any preceding embodiment wherein each R², if present, is independently an organic group that includes 1 to 2 carbon atoms.

Embodiment 12 is the vinyl resole phenolic resin of any preceding embodiment, wherein at least one —C(H)(R³)OR⁴ group is attached at either the ortho- or the para-position relative to the —OR¹ group.

Embodiment 13 is the vinyl resole phenolic resin of any preceding embodiment, wherein each R¹ is independently an organic group including 1 to 12 carbon atoms, 1 to 8 carbon atoms, or 1 to 4 carbon atoms.

Embodiment 14 is the vinyl resole phenolic resin of any preceding embodiment, wherein each R³ is independently an organic group including 1 to 8 carbon atoms, 1 to 5 carbon atoms, or 1 to 2 carbon atoms.

Embodiment 15 is the vinyl resole phenolic resin of any preceding embodiment, wherein each R⁴ is independently an organic group including from 1 to 8 or 1 to 2 carbon atoms.

Embodiment 16 is the vinyl resole phenolic resin of any preceding embodiment, wherein each R⁵ group is independently an alkoxy group, aryl group, aryl ether group, benzyl ether group, or an alternative organic group, each such component including from 1 to 12 carbon atoms, 1 to 8 carbon atoms, or 1 to 4 carbon atoms.

Embodiment 17 is the vinyl resole phenolic resin of any preceding embodiment, further comprising additional monomer constituent units derived from ethylenically unsaturated monomers.

Embodiment 17′ is the vinyl resole phenolic crosslinker of the immediately preceding embodiment, wherein the ethylenically unsaturated monomers comprise styrene, one or more (meth)acrylates, or mixtures thereof.

Embodiment 17″ is the vinyl resole phenolic crosslinker of the immediately preceding embodiment, wherein the ethylenically unsaturated monomers comprise styrene, methyl acrylate, methyl methacrylate, ethyl acrylate, methacrylic acid, n-butyl acrylate, tert-butyl acrylate, tert-butyl methacrylate, n-butyl methacrylate, esters of itaconic acid, vinyl acetate, 2-ethyl hexyl acrylate, bio-based monomers, di-, tri- and tetra-functional acrylates, or mixtures thereof.

Embodiment 18 is the vinyl resole phenolic resin of any preceding embodiment, further comprising additional monomer constituent units selected from the group consisting of esters of itaconic acid, bio-derived (meth)acrylic acid, and alkyl (meth)acrylic acid, and mixtures thereof, and wherein the additional monomer constituent units comprise at least about 5 wt %, at least about 10 wt %, or at least about 15 wt % of the vinyl resole phenolic, based on the total weight of the one or more ethylenically unsaturated monomers providing the additional monomer constituent units relative to the total weight of all monomers used to form the vinyl resole phenolic resin.

Embodiment 19 is the vinyl resole phenolic resin of any of embodiments 1 to 9, wherein the one or more monomer constituent units having the Formula I have the below Formula II:

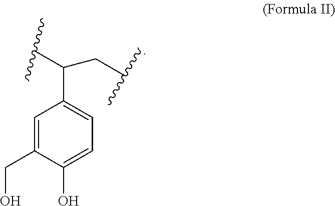 [SMILES: *CC(*)c1ccc(O)c(CO)c1]

Embodiment 20 is the vinyl resole phenolic resin of any preceding embodiment, wherein the one or more monomer constituent units having Formula I comprise at least about 20 wt %, at least about 40 wt %, at least about 50 wt %, at least about 65 wt %, or at least about 85 wt % of the resin, based on the total weight of the one or more ethylenically unsaturated monomers providing the one or more monomer constituent units having Formula I relative to the total weight of all monomers used to form the vinyl resole phenolic resin.

Embodiment 21 is the vinyl resole phenolic resin of any preceding embodiment, wherein the one or more monomer constituent units having Formula I comprise at most about 100 wt %, at most about 95 wt %, at most about 80 wt % or at most about 70 wt % of the resin, based on the total weight of the one or more ethylenically unsaturated monomers providing the one or more monomer constituent units having Formula I relative to the total weight of all monomers used to form the vinyl resole phenolic resin.

Embodiment 21′ is the vinyl resole phenolic resin of any preceding embodiment, wherein the vinyl resole phenolic resin has a hydroxyl number of at least about 467, at least about 500, at least about 575, or at least about 650.

Embodiment 21″ is the vinyl resole phenolic resin of any preceding embodiment, wherein the vinyl resole phenolic resin has a hydroxyl number of at most about 1106, at most about 1000, at most about 900, or at most about 800.

Embodiment 22 is the vinyl resole phenolic resin of any preceding embodiment, wherein the vinyl resole phenolic resin includes less than 10,000 ppm (by weight as a percentage of the solids weight of the vinyl resole phenolic resin), includes less than 1000 ppm, is substantially free, is essentially free, is essentially completely free, or is completely free of at least one of or each of free formaldehyde or phenols, bisphenol A (“BPA”), bisphenol F (“BPF”), bisphenol S (“BPS”), and epoxides of BPA, BPF, and BPS.

Embodiment 23 is the vinyl resole phenolic resin of any preceding embodiment, wherein a backbone of the vinyl resole phenolic resin is substantially free, essentially free, essentially completely free, or optimally completely free of formaldehyde or phenols.

Embodiment 24 is a coating composition including the vinyl resole phenolic resin of any preceding embodiment.

Embodiment 25 is the coating composition of embodiment 24, wherein the coating composition includes at least about 1 wt. % of the vinyl resole phenolic resin, at least about 5 wt. % of the vinyl resole phenolic resin, at least about 10 wt. % of the vinyl resole phenolic resin, at least about 15 wt. % of the vinyl resole phenolic resin, at least about 20 wt. % of the vinyl resole phenolic resin, at least about 30 wt. % of the vinyl resole phenolic resin, or at least about 40 wt. % of the vinyl resole phenolic resin, wherein wt. % is expressed as the nonvolatile vinyl resole phenolic resin content weight as a percentage of nonvolatile coating content weight.

Embodiment 26 is the coating composition of any of embodiments 24 to the embodiment immediately preceding this embodiment, wherein the coating composition includes at most about 95 wt. % of the vinyl resole phenolic resin, at most about 75 wt. % of the vinyl resole phenolic resin, at most about 50 wt. % of the vinyl resole phenolic resin, at most about 30 wt. % of the vinyl resole phenolic resin, or at most about 20 wt. % of the vinyl resole phenolic resin, wherein wt. % is expressed as the nonvolatile vinyl resole phenolic resin content weight as a percentage of nonvolatile coating content weight.

Embodiment 27 is the coating composition of any of embodiments 24 to the embodiment immediately preceding this embodiment, further comprising a second polymer.

Embodiment 28 is the coating composition of the embodiment immediately preceding this embodiment, wherein the coating composition includes at least 5 about wt. % of the second polymer, at least about 25 wt. % of the second polymer, at least about 50 wt. % of the second polymer, at least about 70 wt. % of the second polymer, or at least about 80 wt. % of the second polymer, wherein wt. % is expressed as the nonvolatile second polymer content weight as a percentage of nonvolatile coating content weight.

Embodiment 29 is the coating composition of any of embodiments 27 to the embodiment immediately preceding this embodiment, wherein the coating composition includes at most about 99 wt. % of the second polymer, at most about 90 wt. % of the second polymer, at most about 80 wt. % of the second polymer, at most about 60 wt. % of the second polymer, or at most about 50 wt. % of the second polymer, wherein wt. % is expressed as the nonvolatile second polymer content weight as a percentage of nonvolatile coating content weight.

Embodiment 30 is the coating composition of any of embodiments 27 to the embodiment immediately preceding this embodiment, wherein the second polymer is selected from the group consisting of a polyester polymer, a polyether polymer, an acrylic polymer, a polyolefin polymer, and combinations thereof (including copolymers thereof such as polyether-acrylics).

Embodiment 31 is the coating composition of any of embodiments 27 to the embodiment immediately preceding this embodiment, wherein the second polymer is water dispersible.

Embodiment 32 is the coating composition of any of embodiments 27 to the embodiment immediately preceding this embodiment, wherein the second polymer is selected from the group consisting of a polyester polymer, a polyether polymer, an acrylic polymer, and combinations thereof.

Embodiment 33 is the coating composition of any of embodiments 27 to the embodiment immediately preceding this embodiment, wherein the second polymer is hydroxyl functional.

Embodiment 34 is the coating composition of any of embodiments 27 to the embodiment immediately preceding this embodiment, wherein the second polymer is a polyester polymer.

Embodiment 35 is the coating composition of the immediately preceding embodiment, wherein the polyester polymer has a hydroxyl number of from about 0 to about 150.

Embodiment 36 is the coating composition of embodiment 34, wherein the polyester polymer has an acid number of less than about 20 or less than about 30.

Embodiment 37 is the coating composition of any of embodiments 34 to 36, wherein the polyester polymer exhibits a Tg of at least 0° C., at least 5° C., or at least 10° C.

Embodiment 38 is the coating composition of any of embodiments 34 to 37, wherein the polyester polymer exhibits a Tg of less than 100° C., less than 80° C., or less than 60° C.

Embodiment 38 is the coating composition of any of embodiments 27 to the embodiment immediately preceding this embodiment, wherein the second polymer has a Mn of at least about 1,000, at least about 1,500, at least about 3,000, or at least about 4,000.

Embodiment 39 is the coating composition of any of embodiments 27 to the embodiment immediately preceding this embodiment, wherein the second polymer has a Mn of less than about 120,000, less than about 100,000, 80,000, less than about 20,000, or less than about 10,000.

Embodiment 39′ is the coating composition of any of embodiments 24 to the immediately preceding embodiment, wherein the coating composition further comprises at least one catalyst.

Embodiment 40 is the coating composition of the immediately preceding embodiment, wherein the at least one catalyst is an acid catalyst.

Embodiment 41 is any of the coating compositions of embodiments 39 to 40, wherein the at least one catalyst is present in an amount of at least 0.01 wt % or at least 0.1 wt %, based on the weight of nonvolatile material and an amount of no greater than 3 wt %, and no greater than 1 wt %, based on the weight of nonvolatile material.

Embodiment 41′ is the coating composition of any of embodiments 24 and 25, wherein the coating composition includes about 100 wt. % of the vinyl resole phenolic resin, wherein wt. % is expressed as the nonvolatile vinyl resole phenolic resin content weight as a percentage of nonvolatile coating content weight.

Embodiment 42 is the coating composition of any of embodiments 24 to the embodiment immediately preceding this embodiment, wherein the coating composition includes less than 10,000 ppm, less than 1000 ppm, or is substantially free, essentially free, essentially completely free, or completely free of each of or at least one of free formaldehyde or phenols, BPA, BPS, BPF, or epoxides of BPA, BPS, and BPF.

Embodiment 43 is the coating composition of any of embodiments 24 to the embodiment immediately preceding this embodiment, wherein the coating composition is storage stable for at least 20 days, for at least one month, for at least 3 months, or at least 6 months.

Embodiment 44 is the coating composition of any of embodiments 27 to the embodiment immediately preceding this embodiment, wherein the second polymer has a hydroxyl number of at least about 10, at least about 20, or at least about 30, and a hydroxyl number of at most about 150, at most about 130, at most about 100, at most about 80, or at most about 60, wherein the hydroxyl number is expressed as mg KOH per gram of the second polymer.

Embodiment 45 is the coating composition of any of embodiments 24 to the immediately preceding embodiment, wherein the coating composition further comprises one or more of an additional crosslinker and an additional polymer.

Embodiment 46 is the coating composition of the immediately preceding embodiment, wherein the at least one additional crosslinker is selected from the group consisting of amino crosslinkers, blocked isocyanate crosslinkers, a beta-hydroxyl alkylamide crosslinker, a carbodiimide crosslinker, materials including oxirane groups, and combinations thereof.

Embodiment 47 is the coating composition of embodiments 45 to 46, wherein the at least one additional crosslinker is present in the coating compositions from about 0.01 wt % to about 40 wt %, from about 0.5 wt % to about 35 wt %, or from about 3 wt % to about 30 wt %, wherein wt % is expressed as weight nonvolatile additional crosslinker as a percentage of weight nonvolatile material in the coating composition.

Embodiment 48 is the coating composition of any of embodiments 45 to 47, wherein the at least one additional polymer is selected from the group consisting of a polyether, an acrylic, a poly olefin, and a combination thereof (including copolymers thereof, e.g., polyether-acrylic).

Embodiment 49 is the coating composition of any of embodiments 24 to the embodiment immediately preceding this embodiment, wherein the coating composition further comprises at least one additive selected from the group consisting of emulsifiers, pigments, metal powders or paste, fillers, anti-migration aids, anti-microbials, extenders, curing agents, lubricants, coalescents, wetting agents, biocides, plasticizers, crosslinking agents, antifoaming agents, colorants, waxes, anti-oxidants, anticorrosion agents, flow control agents, thixotropic agents, dispersants, adhesion promoters, UV stabilizers, scavenger agents and combinations thereof.

Embodiment 50 is the coating composition of any of embodiments 24 to the embodiment immediately preceding this embodiment, wherein the coating composition further comprises a carrier.

Embodiment 51 is the coating composition of the immediately preceding embodiment, wherein the carrier is a liquid carrier.

Embodiment 52 is the coating composition of the immediately preceding embodiment, wherein the liquid carrier is selected from water, aliphatic an hydrocarbon, an aromatic hydrocarbon, an alcohol, a ketone, an ester, a glycol, a glycol ether, a glycol ester, tetrahydrofuran, a mixture of ether isomers (e.g., CAS No. 111109-77-4), and a mixture thereof.

Embodiment 53 is the coating composition of the immediately preceding embodiment, wherein the coating composition is a waterborne varnish, and the liquid carrier includes at least about 50 wt % water, at least about 60 wt % is water, or at least about 75 wt % water.

Embodiment 54 is the coating composition of any of embodiments 51 to 53, wherein the coating composition includes at least about 17 wt %, at least about 19 wt. %, at least about 20 wt. %, at least about 30 wt %, at least about 35 wt %, or at least about 40 wt % of solids and less than about 80 wt %, less than about 70 wt %, or less than about 65 wt % of solids, based on the total weight of the coating composition.

Embodiment 55 is the coating composition of any one of embodiments 24 to the embodiment immediately preceding this embodiment, which has a viscosity of at least about 25 centipoise (cps) (25 mPas), at least about 50 mPas, at least about 150 mPas, at least about 500 mPas, or at least about 750 mPas, or at most about 6000 mPas, at most about 5000 mPas, at most about 4000 mPas, at most about 3000 mPas, or at most about 2000 mPas.

Embodiment 56 is the coating composition of any one of embodiments 24 to the embodiment immediately preceding this embodiment, wherein the coating composition is an inside spray coating.

Embodiment 56′ is the coating composition of any one of embodiments 24 to embodiment 55, wherein the coating composition is a roll applied coating.

Embodiment 57 is a coated article, wherein a coating on the coated article is formed from the coating compositions of any of embodiments 24 to the embodiment immediately preceding this embodiment and coated and cured over an article.

Embodiment 58 is a food or beverage container comprising a metal substrate having a surface (in certain embodiments, an inside surface) at least partially coated with the coating composition of any of embodiments 24 to embodiment 56′.

Embodiment 59 is the container of the immediately preceding embodiment, further comprising a fatty food.

Embodiment 60 is the container of any one of embodiments 58 to 59 wherein the coating has an average coating thickness of 1 micron to 20 microns.

Embodiment 61 is a method of coating a food or beverage container, the method comprising: providing a food or beverage container coating composition of any one of embodiments 24 to 56′; applying the coating composition to at least a portion of a metal substrate prior to or after forming the metal substrate into a food or beverage container or portion thereof; and thermally curing the coating composition.

Embodiment 62 is the method of embodiment 61 wherein the substrate is a flat substrate, and the method further comprises forming the flat metal substrate into at least a portion of a food or beverage container after thermally curing the coating composition.

Embodiment 63 is the method of embodiment 61 wherein the metal substrate is in the form of at least a portion of a preformed food or beverage container.

Embodiment 64 is the method of any one of embodiments 61 to 63 wherein applying the coating composition comprises spraying the coating composition onto the metal substrate.

Embodiment 65 is the method of embodiment 64 wherein the metal substrate is in the form of a preformed food or beverage container having a sidewall and a bottom end, and spraying comprises spraying an interior surface of the sidewall and bottom end.

Embodiment 66 is the vinyl resole phenolic resin of any of embodiments 1 to 23 for the manufacture of a coating composition for use in coating food and beverage containers.

Embodiment 67 is the coating composition of any of embodiments 24 to 56′ for use in coating food and beverage containers.

### TEST METHODS

Unless indicated otherwise, the following test methods were utilized in the Examples that follow.

### Solvent Resistance Test (“MEK Double Rubs”)

The extent of “cure” or crosslinking of a coating was measured as a resistance to solvents, such as methyl ethyl ketone (MEK). This test was performed as described in ASTM D 5402-93. The number of double rubs (i.e., one back-and-forth motion) until failure was reported. Preferably, the MEK solvent resistance was at least 30 double rubs (DR). Generally, high MEK rubs indicated high crosslink density which generally corresponded to good solvent (e.g., chemical) resistance. For example, coating films for food cans should be highly crosslinked (at least 30 double rubs, usually at least 50 double rubs) because many of food substances cause corrosion.

### Adhesion Test

The Adhesion test was conducted according to ASTM D3359-17 using Scotch 610 type available from 3M (Saint Paul, MN). Adhesion is generally rated on a scale of 0B to 5B where the scale is based on the percent of the area originally coated with the sample that showed evidence of coating flaking and/or coating removal. Ratings of 5B, 4B, 3B, 2B, 1B, and 0B indicate that 0%, less than 5%, 5%-15%, 15%-35%, 35%-65%, and greater than 65%, respectively, of the area originally coated showed evidence of coating flaking and/or coating removal after completion of the test, respectively. Preferably, an adhesion rating of at least 4B (i.e., 4B or 5B) is considered to be adherent.

### Blush Resistance Test

Blush resistance measures the ability of a coating to resist attack by various solutions. Typically, blush is measured by the amount of water absorbed into a coated film. When the film absorbs water, it generally becomes cloudy or looks white. Blush was measured visually using a scale of 0-5 where a rating of “0” indicates no blush, a rating of “1” indicates slight whitening of the film, and a rating of “3” indicates whitening of the film, and so on. Blush ratings of “2” or less are typically desired for commercial packaging coatings and optimally “1” or less.

### Acid Number (AN) of Resin

The acid number (AN) of a resin may be measured by dissolving a suitable quantity of the resin in a solution of dimethyl formamide (DMF) and methyl ethyl ketone (MEK), then titrating with 0.1 N methanolic KOH and a cresol red/thymol blue or phenolphthalein indicator. Based on the amount of KOH consumed, the acid number is calculated and reported as mg KOH per 1 gram of dry resin.

### Hydroxyl Number of Resin

The hydroxyl value (HN) of a resin may be measured by dissolving a suitable quantity of the resin in Methylene Chloride before mixing the sample for 15-20 minutes with a 4-(dimethylamino) pyridine (DMAP) catalyst solution and a 97% acetic anhydride solution in anhydrous dimethyl formamide (DMF). A solution of DMF and deionized water is then added and the solution is mixed for an additional 15-20 minutes. After supplemental addition of tetrahydrofuran (THF), a titration method with 0.5 N methanolic KOH and a phenolphthalein indicator is used to measure the hydroxyl value of a resin. Based on the amount of KOH consumed as compared to titration of a solution without the resin, the hydroxyl value is calculated and reported as mg KOH per 1 g dry resin.

### Viscosity (I)

ASTM D2196-20 is used to determine the apparent viscosity of non-Newtonian materials. A Brookfield Viscometer DV2T (Brookfield Engineering Laboratories, Middleboro, MA) was used to determine the apparent viscosity using Test Method A of ASTM D2196-20.

### Reverse Impact Test

The reverse impact test measures the coated substrate's ability to withstand the deformation encountered when impacted by steel with a hemispherical head. The test was performed as described in ASTM D2794-93. Briefly, a one pound (0.45 kg) standard metal rod in a cylinder was dropped from a height of 36 inches (91.4 cm) onto the substrate (a BYK Gardner OVERBALL Bend and Impact Tester instrument was used). Following the test, the coating was visually inspected for micro-cracking or microfracture—commonly referred to as crazing. Test pieces were impacted on the uncoated or reversed side. The crazing of the coating was determined via visual assessment. The film was examined for any sign of micro-crazing or crazing with particular attention paid to on stressed/formed areas. A sample failed if crazing or cracks were observed. A sample passed if no crazing or cracks were observed.

### Differential Scanning Calorimetry for Tg

Samples for differential scanning calorimetry (“DSC”) testing are prepared by first applying the liquid resin composition onto aluminum sheet panels. The panels are then baked in a Fisher Isotemp electric oven for 20 minutes at 300° F. (149° C.) to remove volatile materials. After cooling to room temperature, the samples are scraped from the panels, weighed into standard sample pans, and analyzed using the standard DSC heat-cool-heat method. The samples are equilibrated at −60° C., then heated at 20° C. per minute to 200° C., cooled to −60° C., and then heated again at 20° C. per minute to 200° C. Glass transition temperatures are calculated from the thermogram of the last heat cycle. The glass transition is measured at the inflection point of the transition.

### Molecular Weight Determination by Gel Permeation Chromatography

Samples for Gel Permeation Chromatography (“GPC”) testing are prepared by first dissolving the liquid resin in THF. An aliquot of this solution is then analyzed by GPC along with mixtures of polystyrene (“PS”) standards and an epoxy control (Epon 1009F supplied by Hexion, Inc.). The molecular weights of the samples are calculated after processing the GPC runs and verifying the PS and Epon 1009F standards.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts, percentages, and ratios are by weight and all molecular weights are number average molecular weight. Unless otherwise specified, all chemicals used are commercially available from, for example, Sigma-Aldrich, St. Louis, Missouri.

### Example 1

Synthesis of resole-functional poly-hydroxystyrene resin from poly-4-hydroxystyrene polymer: To a 4-neck round-bottom flask equipped with a mechanical stirrer, a nitrogen inlet to maintain a nitrogen blanket, a water-cooled condenser, and a thermocouple connected to heating control device and a heating mantle, was added 10 parts carbitol, 58.5 parts poly-4-hydroxystyrene polymer (40% solids in butanol) (Maruzen Petrochemical Co. Ltd., Japan), 5.0 parts of DMEOA, 18.0 parts paraformaldehyde (96% solids), and 5.0 parts of water. The contents were heated to 75° C. with stirring for six hours. The resulting resin was cooled to room temperature with a 41.4 wt % calculated solids content (as a percentage of total resin weight). The resin had a Brookfield viscosity of 91 cps (Spindle #2, 90 rpm) at 80° F. using ASTM D2196-20.

### Example 2

Synthesis of resole-functional poly-hydroxystyrene resin from poly-4-hydroxystyrene polymer: To a 4-neck round-bottom flask equipped with a mechanical stirrer, a nitrogen inlet to maintain a nitrogen blanket, a water-cooled condenser, and a thermocouple connected to heating control device and a heating mantle, was added 9.8 parts carbitol, 200 parts poly-4-hydroxystyrene polymer (40% solids in butanol) (Maruzen Petrochemical Co. Ltd., Japan), and 4.0 parts water. The contents were heated to 80° C. with stirring, and at temperature, 18.9 parts DMEOA was added. After a 30-minute hold, 20.3 parts paraformaldehyde (96% solids) was added. The mixture was heated to 90° C. with stirring for 5 hours or until the percentage of formaldehyde was less than 3% (Test Method EN ISO 9397 (1997)). At this point, 69.3 parts butanol was added to achieve 30.0% solids solution (as a percentage of total solution weight), and the resulting resin was cooled to room temperature. The resin had a Brookfield viscosity of 106.5 cps (Spindle #2, 60 rpm) at 80° F. using ASTM D2196-20.

### Example 3

Synthesis of resole-functional poly-hydroxystyrene resin from poly-4-hydroxystyrene polymer: To a 4-neck round-bottom flask equipped with a mechanical stirrer, a nitrogen inlet to maintain a nitrogen blanket, a water-cooled condenser, and a thermocouple connected to heating control device and a heating mantle, was added 23.0 parts methanol and 200 parts poly-4-hydroxystyrene polymer (40% solids in butanol) (Maruzen Petrochemical Co. Ltd., Japan). The contents were heated to 70° C. with stirring, and at the temperature, 1.0 parts of NaOH (50% solids in water) was added. After a 30-minute hold, 26.6 parts paraformaldehyde (96% solids) and 6.0 parts butanol were added. The mixture was heated to 75° C. with stirring for 5 hours or until the percentage of formaldehyde was less than 3% (Test Method EN ISO 9397 (1997)). At this point, the resulting resin was cooled to room temperature with a 40.0 wt % calculated solids content (as a percentage of total resin weight). The resin had a Brookfield viscosity of 783 cps (Spindle #2, 30 rpm) at 80° F. using ASTM D2196-20.

### Example 4

Synthesis of unsaturated polyester from nadic anhydride: Cyclohexane-1,4~ dimethanol (626.2 g of a 90% solution in water), 2-methyl-1,3-propanediol (325.8 g), terephthalic acid (158.1 g), isophthalic acid (315.8 g), and dibutyltin oxide (1.9 g) were charged to a 5-liter, 4-neck round bottom flask fitted with a mechanical stirrer, a thermocouple, a packed column (topped with a Dean-Stark trap and condenser), and a stopper for future additions. The contents of the flask were heated slowly (so that the temperature of the distillate did not exceed 100° C.) to 232° C. under a nitrogen atmosphere and held until the acid number dropped to 1.0 mg KOH/g resin. The temperature was then reduced to 170° C., and nadic anhydride (585.0 g) was added to the flask. Following a 1-hour hold at 170° C., xylene (154.9 g) was added to the flask, the packed column was removed, and the trap was pre-filled with xylene in preparation for an azeotrope reflux. The temperature was then raised to 220° C. (or as restricted by reflux) and held until the acid number dropped below 2 mg KOH/g resin. At this point, the resin was cooled to 170° C. and cut to 60% solids with cyclohexanone (1032.5 g). The resulting resin was stirred until uniform, and 2697.0 grams were transferred to a 5-liter flask fitted with a mechanical stirrer, a thermocouple, a condenser, and a stopper for sampling or additions. Pyromellitic dianhydride (86.9 g) was added to the flask, and the contents were heated to 120° C. under a nitrogen atmosphere. After a 4-hour hold at 120° C., cyclohexanone (222.0 g) and AROMATIC 150 solvent (1149.0 g) were added to achieve a 45 wt % solids solution (as a percentage of total solution weight), and the resin was cooled to room temperature.

### Example 5

A solvent based coating composition, Inventive Coating Composition A, was prepared that included 70 wt % solids of the resulting resin from Example 4 with 30 wt % solids of the resulting resin of Example 3, with each wt % expressed as a percentage of total solids in the coating composition. Butyl cellosolve (ethylene glycol monobutyl ether) was used to adjust viscosity at 300-350 centipoise. Surface tension additive BYK 054 was added at 0.1 wt % on total coating composition weight. The coating composition was approximately 39.5 wt % solids as a percentage of total coating composition weight. The resulting coating composition was applied using a wired rod calibrated to apply 6-7 milligrams of dried film per square inch. As a substrate, electrolytic tinplate (ETP) was used, containing a nominal tin weight of 0.25 pounds per base box (5.6 grams per square meter). Substrate and coating were then baked for 11 minutes at 400′ F (204.4° C.). The results of coating performance tests performed on the cured coating are shown in Table 1.

### Example 6

A commercial coating composition, Control Coating Composition B, was prepared that included 75 wt % by solids of the resulting resin from Example 4 with 25 wt % by solids of Bakelite PF 6470LB phenolic crosslinker, available from Hexion, with each wt % expressed as a percentage of total solids in the coating composition. The coating composition was approximately 39.5 wt % solids as a percentage of total coating weight. The resulting coating composition was applied using a wired rod calibrated to apply 6-7 milligrams of dried film per square inch. As a substrate, electrolytic tinplate (ETP) was used, containing a nominal tin weight of 0.25 pounds per base box (5.6 grams per square meter). Substrate and coating were then baked for 11 minutes at 400° F. (204.4° C.). The results of coating performance tests performed on the cured coating are shown in Table 1 below.

### Example 7

Synthesis of functional poly vinylphenol-acrylic resin from poly vinylphenol-acrylic polymer: To a one-liter, four-neck round-bottom flask equipped with a mechanical agitator, a nitrogen inlet, a reflux condenser, and a thermocouple connected to a heating control device and a heating device was added 81.4 parts p-hydroxy-styrene (40% solids in butanol), 8.3 parts paraformaldehyde (96%) and 0.22 parts H₂SO₄ (50% solids in water). This mixture was heated with stirring to 65 to 70° C. until the percentage of formaldehyde was less than 3% (Test Method EN ISO 9397 (1997), and the bubble tube viscosity is in the range of H to M. The resulting resin was cooled to room temperature. The resin had a solid content of 40.32% and number average molecular weight (Mw) of 12780 g/mol by gel permeation chromatography, calibrated by polystyrene standard.

### Example 8

Synthesis of functional poly vinylphenol-acrylic resin from poly vinylphenol-acrylic polymer: To a one-liter, four-neck round-bottom flask equipped with a mechanical agitator, a nitrogen inlet, a reflux condenser, a Dean-Stack receiver, and a thermocouple connected to a heating control device and a heating device was added 16.7 parts butanol, 8.4 parts paraformaldehyde (96%), and 0.50 parts CYCAT 600 (72%). This mixture was heated to 80° C. for three hours or until the percentage of formaldehyde was less than 1% (Test Method EN ISO 9397 (1997). The reaction was cooled to 50° C., and 63.6 parts p-hydroxy-styrene (50% in butanol) was added to the flask. This mixture was heated with stirring to 65 to 70° C. until the bubble tube viscosity is in the range of M to P. The resulting resin was cooled to room temperature. The resin had a solid content of 40.5% and number average molecular weight (Mw) of 37580 g/mol by gel permeation chromatography, calibrated by polystyrene standard.

TABLE 1

| | | Control Coating |
|---|---|---|
| | | Composition B |
| | Inventive Coating | (Commercial |
| Test | Composition A | Control) |
| Dry Adhesion | 10 | 10 |
| Crazing¹ | No crazing (pass) | No crazing (pass) |
| MEK Resistance (double rubs) | >100 | >100 |
| Testing on Water Retort Strip | | |
| Substrates - 90′ @ 250 F.² | | |
| Blush (L/V) | 10/10 | 10/10 |
| Adhesion (L/V) | 10/10 | 10/10 |
| Testing on 2% Salt Retort Strip | | |
| Substrates- 90′ @ 250 F.³ | | |
| Blush (L/V) | 10/10 | 5/10 |
| Adhesion (L/V) | 10/10 | 0/10 |

¹Crazing 26 in lbs/2 lb wt. - direct/reverse impact on flat panel
²90 minutes at 250° F. (121° C.) and 15 psi (~1.05 kg/cm²) in deionized water; L/V Liquid/Vapor.
³90 minutes at 250° F. (121° C.) and 15 psi (~1.05 kg/cm²) in 2% salt deionized water; L/V Liquid/Vapor.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. (canceled)

2. (canceled)

3. (canceled)

4. (canceled)

5. (canceled)

6. (canceled)

7. A coating composition, comprising:
a vinyl resole phenolic resin including one or more monomer constituent units having the below Formula I 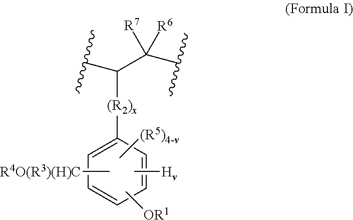
wherein each R¹ is independently a hydrogen or an organic group including 1 to 20 carbon atoms: wherein each R², if present, is independently an organic group having 1 to 3 carbon atoms: wherein the subscript, x, can be zero or 1: wherein each R³ is independently a hydrogen or an organic group including 1 to 10 carbon atoms: wherein each R⁴ is independently hydrogen or an organic group including from 1 to 4 carbon atoms: wherein each R⁵ group is independently an alkoxy group, aryl group, aryl ether group, benzyl ether group, or an alternative organic group, each such component including from 1 to 20 carbon atoms: wherein R⁶ and R⁷ are each independently hydrogen or an organic group including 1 to 8 carbon atoms; and wherein the subscript, v, ranges from 0 to 3; and
a second polymer, optionally, capable of participating in a crosslinking reaction with the vinyl resole phenolic resin.

8. The coating composition of claim 7, further comprising a liquid carrier.

9. The coating composition of claim 7, wherein the coating composition is storage stable for at least one month.

10. The coating composition of claim 7, wherein the coating composition is substantially free of each of bisphenol A, bisphenol F, and bisphenol S, including epoxides thereof.

11. The coating composition of claim 7, wherein the coating composition includes less than 1000 ppm of free formaldehyde.

12. The coating composition of claim 7, wherein the vinyl resole phenolic resin is present in an amount of between about 1 wt % and about 95 wt % as a percentage of nonvolatile coating materials.

13. The coating composition of claim 7, wherein the second polymer is present in an amount of between about 5 wt % and about 99 wt % as a percentage of nonvolatile coating materials.

14. The coating composition of claim 7, wherein the second polymer comprises a polyester polymer, a polyether polymer, an acrylic polymer, a polyolefin polymer, or combinations thereof.

15. The coating composition of claim 7, wherein the second polymer is hydroxyl functional.

16. The coating composition of claim 15, wherein the second polymer has a hydroxyl number of at least 20 mg KOH per gram of the second polymer.

17. The coating composition of claim 7, further comprising one or more of an additional crosslinker, an additional polymer, and additional additives.

18. The composition of claim 17, wherein the composition further comprises an aminoplast crosslinker, a blocked isocyanate crosslinker, a beta-hydroxyl alkylamide crosslinker, a carbodiimide crosslinker, or a mixture thereof.

19. A food or beverage container, or portion thereof, comprising:
a body portion or an end portion comprising a metal substrate; and
a coating present on at least a portion of the metal substrate, the coating formed from a coating composition comprising:
a second polymer optionally, and preferably, capable of participating in a crosslinking reaction with the vinyl resole phenolic resin;
optionally a carrier; and
a vinyl resole phenolic resin including one or more monomer constituent units of the below Formula I 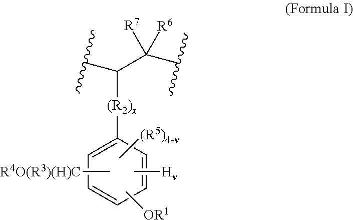
wherein R¹ is a hydrogen or an organic group including 1 to 20 carbon atoms; wherein R², if present, is an organic group having 1 to 3 carbon atoms; wherein the subscript, x, is zero or 1; wherein each R³ is independently a hydrogen or an organic group including 1 to 10 carbon atoms; wherein each R⁴ is independently hydrogen or an organic group including from 1 to 4 carbon atoms; wherein each R⁵ group is independently an alkoxy group, aryl group, aryl ether group, benzyl ether group, or an alternative organic group, each such component including from 1 to 20 carbon atoms; wherein R⁶ and R⁷ are each independently hydrogen or an organic group including 1 to 8 carbon atoms; and wherein the subscript, v, ranges from 0 to 3.

20. The food or beverage container of claim 19, wherein the coating composition is applied on a food-contact surface.

21. The food or beverage container of claim 19, wherein the coating composition further comprises an additional crosslinker.

22. The food or beverage container of claim 19, wherein the coating composition includes at least about 20 wt. % to at most about 65 wt. % of solids as a percent of coating weight.

23. A method comprising:
providing the coating composition of claim 7; and
applying the coating composition on a metal substrate prior to, or after, forming the metal substrate into a food or beverage container or a portion thereof.

24. The method of claim 23, further comprising the step of curing the applied coating composition via thermal curing.

25. A method comprising:
providing the coating composition of claim 7; and
causing the coating composition to be applied on a metal substrate prior to, or after, forming the metal substrate into a food or beverage container or a portion thereof.
